(19) United States
(12) Patent Application Publication
(10) Pub. No.: US 2016/0092963 A1
(43) Pub. Date: Mar. 31, 2016

(54) BEHAVIOR SUPPORTING APPARATUS, BEHAVIOR SUPPORTING SYSTEM, AND BEHAVIOR SUPPORTING METHOD

(71) Applicant: SEIKO EPSON CORPORATION, Tokyo (JP)

(72) Inventor: Michihiro NAGAISHI, Suwa-shi (JP)

(21) Appl. No.: 14/869,343

(22) Filed: Sep. 29, 2015

(30) Foreign Application Priority Data
Sep. 30, 2014 (JP) 2014-201794
Sep. 30, 2014 (JP) 2014-201837

(51) Int. Cl. G06Q 30/06

(52) U.S. Cl. CPC G06Q 30/0631

(57) ABSTRACT

A behavior supporting apparatus according to the invention includes a biological-information detecting unit configured to detect biological information of a user, a desire estimating unit configured to estimate a desire of the user on the basis of the detected biological information, and a behavior presenting unit configured to present behavior with which the user can enjoy at least one of a service and an article corresponding to the estimated desire of the user.

This application claims priority to Japanese Patent Application No. 2014-201794, filed Sep. 30, 2014, and No. 2014-201837, filed Sep. 30, 2014, all the entireties of which are hereby incorporated by reference.

### BACKGROUND

1. Technical Field

The present invention relates to a behavior supporting apparatus, a behavior supporting system, and a behavior supporting method.

2. Related Art

There has been proposed a shopping assist system that guides a customer to a desired commodity display position in a store and assists shopping (see, for example, JP-A-2012-185581).

The shopping assist system described in JP-A-2012-185581 includes a POS (Point Of Sales) system, a cart attached with a shopping assist terminal device, and a route navigation system. Therefore, in the shopping assist system, when a user inputs a desired commodity to an input screen of the shopping assist terminal device attached to the cart, the route navigation system sets a guide route for guiding the user to a display position of the input purchase planned commodity and guides the user in the store according to the set guide route.

However, in the shopping assist system described in JP-A-2012-185581, the user needs to select a commodity that the user desires to purchase. The use of the system is limited to when the user is located in the store where the shopping assist system is provided. For example, when the user is located outside the store, the user cannot use the system. Further, since the user himself or herself inputs or selects a commodity that the user desires to purchase, it is likely that the shopping assist system cannot always provide a commodity and a service that the user potentially desires.

In the shopping assist system described in JP-A-2012-185581, the user inputs or selects, with the shopping assist terminal, a commodity that the user desires to purchase and the shopping assist system guides the user to a display position of the commodity. Therefore, it is not determined whether the commodity is suitable for a state of the user. Consequently, it is likely that the user purchases a commodity not suitable for the user.

### SUMMARY

An advantage of some aspects of the invention is to solve at least a part of the problems and provide a behavior supporting apparatus, a behavior supporting system, and a behavior supporting method that can present behavior with which a user can enjoy at least one of a service or a commodity potentially desired by a user or suitable for the user.

A behavior supporting apparatus according to a first aspect of the invention includes: a biological-information detecting unit configured to detect biological information of a user; a desire estimating unit configured to estimate a desire of the user on the basis of the detected biological information; and a behavior presenting unit configured to present behavior with which the user can enjoy at least one of a service and an article corresponding to the estimated desire of the user.

Note that the desire includes not only a desire that the user is aware of but also a desire that the user is not aware of and includes best behavior content and a best choice that the user should select according to a situation irrespective of whether the user is aware of or not aware of the desire.

According to the first aspect, a desire of the user is estimated on the basis of the biological information. Behavior with which the user can enjoy at least one of a service or an article corresponding to the estimated desire is presented. Since such behavior is presented, it is possible to easily cause the user to recognize behavior with which the user can enjoy at least one of a service and an article that the user potentially desires, although not being aware of the desire. Therefore, the user can satisfy the potential desire of the user by executing the presented behavior.

In the first aspect, it is preferable that the behavior supporting apparatus further includes an abnormality determining unit configured to determine whether the detected biological information is within a normal range, and the desire estimating unit estimates a desire of the user when it is determined that the biological information is not within the normal range.

Note that the biological information is not within the normal range, for example, when abnormality (psychological or physical abnormality) occurs in the user or when a symptom such as a hypoglycemia symptom or a heat stroke symptom occurs.

According to the first aspect with this configuration, when the abnormality determining unit determines that the biological information of the user is not within the normal range, the desire estimating unit estimates a potential desire of the user on the basis of the biological information. Consequently, for example, when it is determined that a hypoglycemia symptom in which a blood sugar level serving as the biological information is low occurs, it is possible to estimate a potential desire of the user to take sugar (glucose). For example, when it is determined that body temperature serving as the biological information is high, a perspiration amount also serving as the biological information is large, and a heat stroke symptom occurs, it is possible to estimate a potential desire of the user to take water and salt.

Therefore, even when the user does not notice abnormality of the body, it is possible to present behavior for relieving the user of the abnormality of the body. It is possible to quickly solve an abnormal state of the body.

In the first aspect, it is preferable that the behavior supporting apparatus further includes a body-motion-information detecting unit configured to detect body motion information of the user, and the desire estimating unit estimates a desire of the user on the basis of the detected biological information and the detected body motion information.

According to the first aspect with this configuration, it is possible to estimate a potential desire of the user on the basis of the biological information and the body motion information. For example, when it is determined that a blood sugar level detected as the biological information is relatively low and a hypoglycemia symptom occurs, it is possible to grasp a degree of the hypoglycemia symptom on the basis of intensity of exercise performed by the user. In this case, for example, when the hypoglycemia symptom is serious, it is possible to present behavior with which the user can enjoy immediately-effective sugar. Therefore, it is possible to present behavior further adapted to a state of the body of the user.

In the first aspect, it is preferable that the behavior supporting apparatus further includes: a notifying unit configured to notify various kinds of information; and an article-information acquiring unit configured to acquire, from a server configuring a point-of-sales-information managing system that manages article information concerning each of a plurality of articles, the article information concerning an article corresponding to a desire of the user, and the behavior presenting unit causes the notifying unit to notify the article information acquired by the article-information acquiring unit.

Note that the point-of-sales-information managing system is a so-called POS system configured by a store such as a supermarket or a convenience store, an apparatus such as a vending machine, and a server that communicates with the store and the apparatus via a network and executes, for example, inventory management of articles. Examples of the article information include a name, explanation, a list price (a recommended retail price), and a photograph of the article.

According to the first aspect with this configuration, article information concerning an article corresponding to a desire of the user is acquired from the server configuring the point-of-sales-information managing system. The article information is notified by the notifying unit. Therefore, it is possible to easily cause the user to recognize article information concerning an article that the user potentially desires. Therefore, it is possible to cause the user to grasp detailed information concerning the article.

In the first aspect, it is preferable that the behavior supporting apparatus further includes: a notifying unit configured to notify various kinds of information; a position-information acquiring unit configured to acquire a present position of the user; and a place-information acquiring unit configured to acquire, from a server configuring a point-of-sales-information managing system that manages place information concerning a providing place where an article and a service can be provided, on the basis of the acquired present position of the user, the place information indicating a place where the user can enjoy at least one of a service and an article corresponding to a desire of the user, and the behavior presenting unit causes the notifying unit to notify the acquired place information.

According to the first aspect with this configuration, place information concerning a place where the user can enjoy at least one of a service and an article necessary for the user is acquired from the server configuring the point-of-sales-information managing system. The acquired place information is notified to the user. Consequently, it is possible to easily cause the user to recognize a providing place where the user can enjoy at least one of a service and an article that the user potentially desires. Since place information indicating the providing place is acquired on the basis of a present position of the user, it is possible to notify the user of a providing place relatively close to the present position. Therefore, it is possible to improve convenience of the behavior supporting apparatus.

In the first aspect, it is preferable that the behavior supporting apparatus further includes a route generating unit configured to generate a route from the present position of the user to a place indicated by the place information, and the behavior presenting unit causes the notifying unit to notify one of the generated route and time required in moving along the route.

According to the first aspect with this configuration, one of a route to a providing place where the user can enjoy one of a service and an article corresponding to a desire of the user and time required in moving along the route is notified. Consequently, it is possible to easily cause the user to recognize the route to the providing place of the service and the article corresponding to the desire of the user and the time required in moving along the route.

In the first aspect, it is preferable that the behavior supporting apparatus further includes a user-information acquiring unit configured to acquire user information including a behavior history of the user acquired from the position information of the user detected by the position-information acquiring unit, and the behavior presenting unit presents behavior based on the user information.

Note that examples of the behavior history include “when and where the user went” and “a running route of everyday running”. Examples of the user information include an attribute, presence or absence of a symptom, and taste in food of the user in addition to the behavior history.

If a state of pupils and a heartbeat are detected as the biological information of the user and a state of the user is a state in which a sleeping desire is high, for example, it is conceivable to present drinking of coffee. However, it is possible that the user does not like coffee.

On the other hand, according to the first aspect with the configuration described above, when behavior corresponding to a desire of the user is presented, user information concerning the user (in this case, taste in food of the user) is also referred to besides the biological information. Consequently, for example, if the user does not usually drink coffee at all, it is possible to present drinking of another beverage containing caffeine instead of coffee. Therefore, it is possible to present behavior corresponding to a need of the user.

In the first aspect, it is preferable that the behavior supporting apparatus further includes: a storing unit configured to store a table in which the detected biological information, an estimated desire of the user, and means for satisfying the desire of the user are associated; and a treatment method determining unit configured to determine, on the basis of the table, a treatment method that satisfies the desire of the user.

According to the first aspect with this configuration, the treatment method determining unit determines, on the basis of the table, a treatment method that satisfies the desire of the user. The behavior presenting unit presents behavior corresponding to the determined treatment method. Therefore, it is possible to accurately and quickly execute presentation of the behavior with which the user can enjoy the service and the article. Therefore, it is possible to simplify processing concerning the presentation of the behavior. Besides, it is possible to quickly satisfy a potential desire of the user.

In the first aspect, it is preferable that the biological information includes at least any one of a pulse wave, a heartbeat, a blood pressure, a body temperature, a blood sugar level, a perspiration amount, and a state of pupils of the user.

According to the first aspect with this configuration, since the pulse wave or the like is acquired as the biological information, it is possible to estimate a desire of the user on the basis of the biological information in detail and accurately. For example, if the pulse wave (a pulse) and the body temperature are high and the perspiration amount is large, a symptom of a heat stroke is doubted. Therefore, the desire estimating unit can estimate that the body of the user desires water. For example, if the pulse wave or the heartbeat is low and movement of the pupils is less, the desire estimating unit can estimate that a sleeping desire is high. Therefore, it is possible to surely and appropriately grasp a potential desire of the user and appropriately present behavior that satisfies the desire.

A behavior supporting system according to a second aspect of the invention includes: a detecting apparatus configured to detect and transmit biological information of a user; and a server configured to process the biological information transmitted from the detecting apparatus. The detecting apparatus includes: a biological-information detecting unit configured to detect the biological information; a detecting-apparatus-side transmitting unit configured to transmit the detected biological information; and a notifying unit configured to notify information received from the server. The server includes: a desire estimating unit configured to estimate a desire of the user on the basis of the biological information received from the detecting apparatus; a behavior presenting unit configured to present behavior with which the user can enjoy at least one of a service and an article corresponding to the estimated desire of the user; and a server-side transmitting unit configured to transmit behavior information indicating the behavior to the detecting apparatus.

According to the second aspect, it is possible to attain effects same as the effects of the behavior supporting apparatus according to the first aspect. If the detecting apparatus includes only the biological-information detecting unit, the detecting-apparatus-side transmitting unit, and the notifying unit and the server includes only the desire estimating unit, the behavior presenting unit, and the server-side transmitting unit, it is possible to simplify the configuration of a control unit of the detecting apparatus. Therefore, it is possible to attain a reduction in the costs, a reduction in the weight, and a reduction in the size of the detecting apparatus.

A behavior supporting method according to a third aspect of the invention includes: detecting biological information of a user; estimating a desire of the user on the basis of the detected biological information; and presenting behavior with which the user can enjoy at least one of a service and an article corresponding to the estimated desire of the user.

According to the third aspect, a behavior supporting apparatus executes processing conforming to the behavior supporting method according to the third aspect. Therefore, it is possible to attain effects same as the effects of the behavior supporting apparatus according to the first aspect.

A behavior supporting apparatus according to a fourth aspect of the invention includes: a biological-information detecting unit configured to detect biological information of a user; an input unit to which desired behavior, which is behavior that the user desires to carry out, is input; a desired-behavior acquiring unit configured to acquire behavior content of the input desired behavior; a behavior determining unit configured to determine on the basis of the detected biological information whether the user has a problem in carrying out the desired behavior; and a behavior presenting unit configured to present, when the behavior determining unit determines that the user has a problem in carrying out the desired behavior, on the basis of the biological information, alternative behavior that the user is determined by the behavior determining unit as having no problem in carrying out.

According to the fourth aspect, it is determined on the basis of biological information whether the user has a problem in carrying out desired behavior that the user desires to carry out. When it is determined that the user has a problem, alternative behavior that the user has no problem in carrying out is proposed on the basis of the biological information and the alternative behavior is presented.

Consequently, it is possible to prevent desired behavior that the user has a problem in carrying out from being carried out. It is possible to urge the user to carry out the alternative behavior that is an alternative for the desired behavior. Therefore, the user can execute behavior suitable for a state of the user by executing the presented alternative behavior.

In the fourth aspect, it is preferable that the alternative behavior is behavior that is based on the biological information and conforms to the desired behavior and that the user is determined by the behavior determining unit as having no problem in carrying out.

According to the fourth aspect with this configuration, the alternative behavior is behavior conforming to the desired behavior. Consequently, since the alternative behavior conforming to the desired behavior of the user is presented, it is possible to make it easy to urge the user to perform the alternative behavior. Besides, it is possible to suppress resistance of the user in carrying out the alternative behavior. Therefore, it is possible to make it easy to cause the user to execute behavior suitable for a state of the user.

In the fourth aspect, it is preferable that the desired behavior is behavior with which the user enjoys an enjoyment target including at least one of a service and an article.

According to the fourth aspect with this configuration, when the user has a problem in carrying out the desired behavior, it is possible to propose the alternative behavior in which the enjoyment target is changed. That is, when the user has a problem in carrying out the desired behavior, by changing the enjoyment target, it is possible to propose an alternative behavior that is an alternative of the desired behavior. Therefore, it is possible to easily propose and present the alternative behavior.

In the fourth aspect, it is preferable that the behavior supporting apparatus further includes an article-information acquiring unit configured to acquire, from an information processing apparatus that manages article information concerning each of a plurality of articles, the article information concerning an article included in the enjoyment target of the alternative behavior, and the behavior presenting unit presents the article information acquired by the article-information acquiring unit.

Note that examples of the information processing apparatus include a server configuring a point-of-sales-information managing system (a so-called POS system). The point-of-sales-information managing system is configured by, for example, a store such as a supermarket or a convenience store, an apparatus such as a vending machine, and the server that communicates with the store and the apparatus via a network and executes, for example, inventory management of articles. Examples of the article information include a name, explanation, a list price (a recommended retail price), and a photograph of the article.

According to the fourth aspect with this configuration, article information concerning an article included in the enjoyment target of the alternative behavior is acquired from the information processing apparatus and presented. Consequently, it is possible to present the user with article information concerning the article matching a state of the user and included in the enjoyment target of the alternative behavior changed from the enjoyment target of the desired behavior. Therefore, it is possible to present detail information concerning the article to the user. The behavior supporting apparatus does not need to retain article information concerning respective articles that are likely to be presented. Therefore, when the behavior supporting apparatus includes a storing unit configured to store desired information, it is possible to reduce a storage capacity of the storing unit.

In the fourth aspect, it is preferable that the behavior supporting apparatus further includes: a position-information acquiring unit configured to acquire a present position of the user; and a place-information acquiring unit configured to acquire, from an information processing apparatus that manages place information concerning a providing place where an article and a service can be provided, on the basis of the acquired present position, the place information indicating a place where the user can enjoy the enjoyment target corresponding to at least one of the desired behavior and the alternative behavior, and the behavior presenting unit presents the acquired place information.

Note that, as explained above, examples of the information processing apparatus include an information processing apparatus configuring a point-of-sales-information managing system.

According to the fourth aspect with this configuration, place information concerning a place where the enjoyment target of the alternative behavior can be enjoyed is acquired from the information processing apparatus and presented to the user. Consequently, it is possible to cause the user to grasp the place where the enjoyment target of the alternative behavior can be enjoyed. The place information presented in this way is place information acquired on the basis of the present position of the user. Therefore, for example, it is possible to present the user with a providing place relatively close to the present position. Therefore, the user can easily carry out the alternative behavior.

In the fourth aspect, it is preferable that the behavior presenting unit presents at least one of a route from the present position to the place where the enjoyment target can be enjoyed and time required in moving from the present position to the place where the enjoyment target can be enjoyed.

According to the fourth aspect with this configuration, at least one of the route and the required time is presented. Therefore, the user can more easily carry out the presented alternative behavior.

In the fourth aspect, it is preferable that the behavior supporting apparatus further includes a user-information acquiring unit configured to acquire user information, which is information concerning the user input to the input unit, and the behavior presenting unit presents the alternative behavior based on the user information.

Note that examples of the user information include an attribute, a medical history, taste in food, a habit, and a behavior history of the user.

For example, when the biological-information detecting unit detects a blood pressure as the biological information and the desired behavior of the user is “take a hot spring”, if the user is in a high blood pressure state, it is conceivable to present, as alternative behavior, bathing in a hot spring with relatively low water temperature. However, depending on a medical history of the user, for example, full-body bathing is sometimes undesirable even if water temperature is low.

On the other hand, according to the fourth aspect with the configuration described above, when the alternative behavior conforming to the desired behavior of the user is presented, the alternative behavior based on the user information besides the biological information is presented. Consequently, for example, it is possible to present a user for whom the full-body bathing is undesirable with alternative behavior of taking a hot spring in half-body bathing or alternative behavior of taking a footbath. Therefore, it is possible to present behavior more suitable for a state of the user.

In the fourth aspect, it is preferable that the behavior determining unit determines, on the basis of whether the detected biological information is within a normal range, whether the user has a problem in carrying out the desired behavior.

According to the fourth aspect with this configuration, for example, when the biological-information detecting unit detects a blood sugar level as the biological information and the desired behavior of the user is “eat an ice cream”, if the detected blood sugar level of the user is a value classified into hyperglycemia, it is possible to present alternative behavior of “drink sports drink containing less sugar than the ice cream” instead of the desired behavior. Therefore, even when the user does not notice abnormality of the body, it is possible to present alternative behavior suitable for the body. It is possible to urge the user to perform behavior for changing a state of the user to a satisfactory state.

In the fourth aspect, it is preferable that the behavior supporting apparatus further includes a body-motion-information detecting unit configured to detect body motion information of the user, and the behavior determining unit determines on the basis of the biological information and the body motion information whether the user has a problem in carrying out the desired behavior.

According to the fourth aspect with this configuration, it is determined on the basis of not only the biological information detected by the biological-information detecting unit but also the body motion information detected by the body-motion-information detecting unit whether the user has a problem in carrying out the desired behavior. Consequently, it is possible to more appropriately detect and grasp a state of the user. Therefore, it is possible to more appropriately determine whether the user has a problem in carrying out the desired behavior and whether alternative behavior needs to be proposed and presented.

In the fourth aspect, it is preferable that the behavior supporting apparatus further includes: a storing unit configured to store a table in which the desired behavior, the biological information, and the alternative behavior are associated; and an alternative-behavior determining unit configured to determine, on the basis of the table, the alternative behavior corresponding to the input desired behavior and the detected biological information, and the behavior presenting unit presents the determined alternative behavior.

According to the fourth aspect with this configuration, the alternative-behavior determining unit determines alternative behavior conforming to the desired behavior on the basis of the table stored in the storing unit. Consequently, it is possible to accurately and easily determine presented behavior presented by the behavior presenting unit. Therefore, it is possible to simplify processing concerning proposal and determination of the alternative behavior. Besides, it is possible to surely present alternative behavior suitable for the user.

In the fourth aspect, it is preferable that the biological-information detecting unit detects, as the biological information, at least any one of a pulse wave, a heartbeat, a blood pressure, a body temperature, a blood sugar level, a perspiration amount, and blood alcohol concentration of the user.

According to the fourth aspect with this configuration, the biological-information detecting unit can determine in detail and appropriately, by detecting the biological information, on the basis of the biological information, whether the user has a problem in carrying out the desired behavior.

A behavior supporting system according to a fifth aspect of the invention includes: a detecting apparatus configured to detect and transmit biological information of a user; and an information processing apparatus configured to process the biological information transmitted from the detecting apparatus. The detecting apparatus includes: a biological-information detecting unit configured to detect the biological information; an input unit to which desired behavior, which is behavior that the user desires to carry out, is input; a desired-behavior acquiring unit configured to acquire behavior content of the input desired behavior; a detecting-apparatus-side transmitting unit configured to transmit the detected biological information and the acquired behavior content of the desired behavior; and a notifying unit configured to notify information received from the information processing apparatus. The information processing apparatus includes: a behavior determining unit configured to determine on the basis of the biological information received from the detecting apparatus whether the user has a problem in carrying out the desired behavior; a behavior presenting unit configured to present, when the behavior determining unit determines that the user has a problem in carrying out the desired behavior, on the basis of the biological information, alternative behavior that the user is determined by the behavior determining unit as having no problem in carrying out; and a processing-apparatus-side transmitting unit configured to transmit behavior information indicating the alternative behavior to the detecting apparatus.

According to the fifth aspect, it is possible to attain effects same as the effects of the behavior supporting apparatus according to the fourth aspect. The information processing apparatus performs determination processing by the behavior determining unit and the proposal processing for alternative behavior by the behavior presenting unit. Therefore, the information processing apparatus executes the processing that consumes relatively large electric power and has a large processing load. Consequently, it is possible to cause the detecting apparatus to operate for a relatively long time. Besides, it is possible to attain a reduction in costs.

A behavior proposing method according to a sixth aspect of the invention is a behavior proposing method performed using a behavior supporting apparatus that proposes behavior corresponding to biological information of a user. The behavior proposing method includes: acquiring behavior content of desired behavior input by the user and desired by the user to carry out; determining on the basis of the biological information of the user whether the user has a problem in carrying out the desired behavior; and proposing, when it is determined that the user has a problem in carrying out the desired behavior, on the basis of the biological information, alternative behavior that the user is determined as having no problem in carrying out.

According to the sixth aspect, the behavior supporting apparatus executes the behavior proposing method according to the sixth embodiment. Consequently, it is possible to attain effects same as the effects of the behavior supporting apparatus according to the fourth aspect.

### BRIEF DESCRIPTION OF THE DRAWINGS

The invention will be described with reference to the accompanying drawings, wherein like numbers reference like elements.

FIG. 1 is a schematic diagram showing a behavior supporting system according to a first embodiment of the invention.

FIG. 2 is a schematic diagram showing the configuration of a server configuring a POS system in the first embodiment.

FIG. 3 is a diagram showing details of commodity explanation in a storing unit of the server in the first embodiment.

FIG. 4 is a block diagram showing the configuration of a behavior supporting apparatus in the first embodiment.

FIG. 5 is a block diagram showing the configuration of a control unit of the behavior supporting apparatus in the first embodiment.

FIG. 6 is a diagram showing a hypoglycemia treatment table in the first embodiment.

FIG. 7 is a diagram showing an example of a screen on which behavior proposal information is presented in the first embodiment.

FIG. 8 is a diagram showing an example in which commodity information of a commodity that should be acquired and routes to stores selling the commodity are presented in behavior presentation processing in the first embodiment.

FIG. 9 is a diagram showing an example in which the behavior presentation processing in a vending machine is executed in the first embodiment.

FIG. 10 is a flowchart for explaining notification control processing in the first embodiment.

FIG. 11 is a flowchart for explaining the behavior presentation processing in the first embodiment.

FIG. 12 is a diagram showing a heat stroke treatment table stored in a storing unit of the behavior supporting apparatus according to a second embodiment of the invention.

FIG. 13 is a diagram showing an example of a screen on which behavior proposal information is presented in the second embodiment.

FIG. 14 is a diagram showing an example of a screen on which behavior proposal information and a route to a parking area where a commodity that should be acquired is sold are presented in behavior presentation processing according to a third embodiment of the invention.

FIG. 15 is a block diagram showing the configuration of a behavior supporting apparatus according to a fourth embodiment of the invention.

FIG. 16 is a diagram showing an example of a sugar intake determination table in the fourth embodiment.

FIG. 17 is a diagram showing an example of a drinking determination table in the fourth embodiment.

FIG. 18 is a diagram showing an example of a bathing determination table in the fourth embodiment.

FIG. 19 is a block diagram showing the configuration of a control unit of the behavior supporting apparatus in the fourth embodiment.

FIG. 20 is a diagram showing an example of an information presentation screen in the fourth embodiment.

FIG. 21 is a diagram showing an example of a route guide screen in the fourth embodiment.

FIG. 22 is a diagram showing an example in which commodity presentation processing in a vending machine is executed in the fourth embodiment.

FIG. 23 is a diagram showing an example of an information presentation screen in the fourth embodiment.

FIG. 24 is a diagram showing an example of a route guide screen in the fourth embodiment.

FIG. 25 is a flowchart for explaining presentation control processing in the fourth embodiment.

FIG. 26 is a flowchart for explaining behavior presentation processing in the fourth embodiment.

FIG. 27 is a block diagram showing the configuration of a control unit of a behavior supporting apparatus configuring a behavior supporting system according to a fifth embodiment of the invention.

FIG. 28 is a block diagram showing the configuration of a server in the fifth embodiment.

### DESCRIPTION OF EXEMPLARY EMBODIMENTS

### First Embodiment

A first embodiment of the invention is explained below with reference to the drawings.

### Overview of a Behavior Presenting System

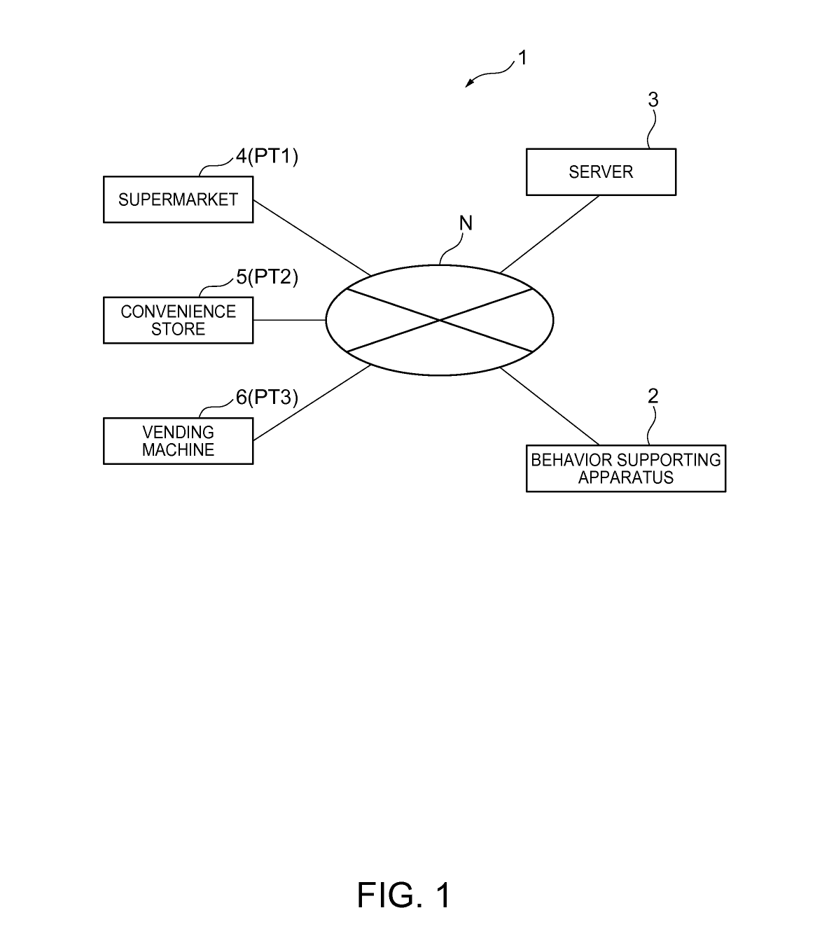

FIG. 1 is a schematic diagram showing the configuration of a behavior supporting system 1 according to this embodiment.

The behavior supporting system 1 includes, as shown in FIG. 1, a behavior supporting apparatus 2 used by a user, a server 3, a terminal apparatus PT1 set in a supermarket 4, a terminal apparatus PT2 set in a convenience store 5, and a vending machine 6. The server 3 and the terminal apparatuses PT1 and PT2 and a terminal apparatus PT3 incorporated in the vending machine 6 are capable of communicating with each other via a network N.

Commodity information (product information) concerning commodities (products) respectively sold in the supermarket 4, the convenience store 5, and the vending machine 6 is managed by the server 3 on the basis of information transmitted and received via the terminal apparatuses PT1 to PT3. That is, a point-of-sales information managing system (a so-called POS system) is configured by the server 3 and the terminal apparatuses PT1 to PT3. The behavior supporting apparatus 2 and the server 3 are capable of communicating with each other via the network N. Note that the POS system is a system that retains information concerning a service and an article to be provided (service information and article information) and totalizes a sales achievement and the like in single item units at a point of sales of the article.

In the behavior supporting system 1, the behavior supporting apparatus 2 estimates a potential desire of the user on the basis of biological information, body motion information, and user information including a behavior history of the user and presents behavior with which the user can enjoy a service and an article that satisfy the estimated desire. In this case, when presenting behavior for acquiring an article that satisfies a desire of the user, the behavior supporting apparatus 2 satisfies a potential desire of the user by acquiring information concerning the article from the server 3 configuring the POS system and showing, together with the presented behavior, for example, a route to a place (e.g., a store and a vending machine) where the article can be presented.

The behavior supporting apparatus 2 and the server 3 are explained below.

### Configuration of the Server

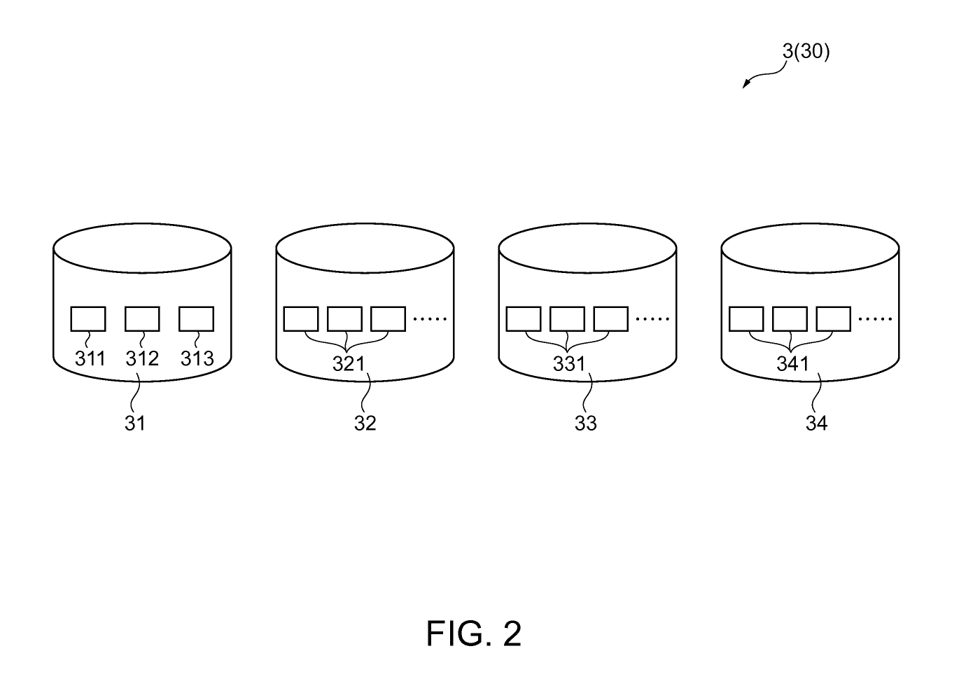

FIG. 2 is a schematic diagram showing the configuration of the server 3 configuring the POS system.

In the POS system according to this embodiment, the server 3 manages article information of articles sold in the supermarket 4, the convenience store 5, and the vending machine 6 and sales information (inventory states in the stores and the vending machine) of the articles, and the like.

The server 3 includes a control unit (not shown in the figure) including a CPU (Central Processing Unit) that controls the operation of the server 3. Besides, the server 3 includes, as shown in FIG. 2, a storing unit 30. The storing unit 30 has stored therein a database 31 in which information concerning services and commodities and information concerning stores are set, a database 32 in which information indicating commodities (e.g., a commodity ₁ to a commodity ₙ) sold in the supermarket 4 is set, a database 33 in which information concerning commodities sold in the convenience store 5 is set, and a database 34 in which information concerning commodities sold by the vending machine 6 is set.

Specifically, the database 31 includes a content table 311, a detailed information table 312, and a store information table 313.

In the content table 311, contents of the services and the commodities are set. In the content table 311, service IDs or commodity IDs (e.g., JAN codes), service names or commodity names, explanation of the services or the commodities, photographs of the commodities, categories of the services or the commodities, and store IDs indicating stores that provide the services or the commodities are set as setting items. The information concerning the services and the commodities is set in these setting items.

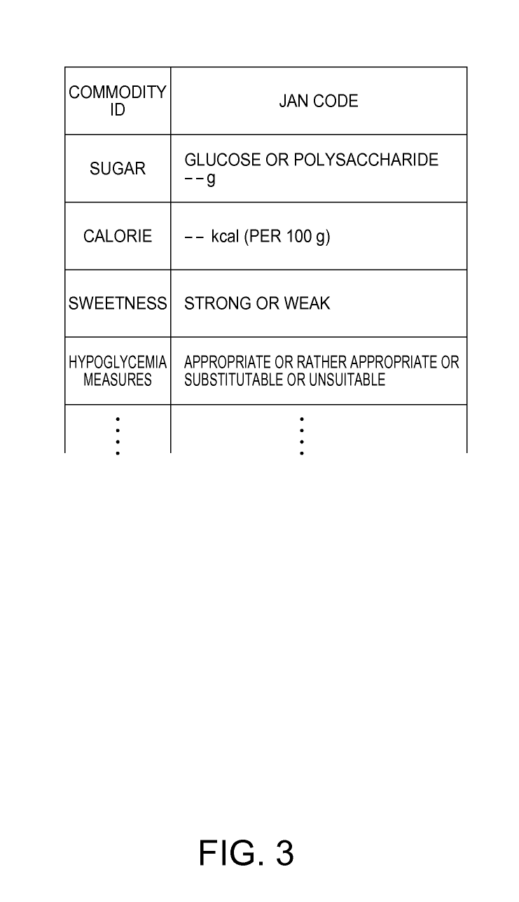

FIG. 3 is a diagram showing the detailed information table 312 included in the database 31.

The detailed information table 312 is a table in which detailed information of the commodities is set. In this embodiment, items such as a commodity ID, sugar, calorie, sweetness, and hypoglycemia measures are set.

Among these items, in a column of the sugar, one of glucose and polysaccharide is set as a type of sugar included in the commodity and a content of the sugar is set. In a column of the calorie, calorie per 100 g of the commodity is set. In a column of the sweetness, whether the sweetness is strong or weak is set.

In a column of the hypoglycemia measures, whether intake is suitable for improvement of a hypoglycemia symptom when the hypoglycemia symptom occurs in the user is set. Specifically, in the column of the hypoglycemia measures, any one of “suitable”, “rather suitable”, “substitutable (substitutable by others)”, and “unsuitable” is set.

In this embodiment, in the detailed information table, the four items (the sugar, the calories, the sweetness, and the hypoglycemia measures) are set besides the commodity ID. However, other items may be set instead of or in addition to the items.

In the store information table 313, information concerning the supermarket 4 and the convenience store 5, stores that provide the services, and the vending machine 6 is set. In the store information table, store IDs for identifying the stores (including the vending machine 6), business information (opening hours and regular holidays) of the stores, and position information indicating positions of the stores are set. That is, the store IDs are respectively set for the supermarket 4, the convenience store 5, the vending machine 6, and the stores that provide the services.

The database 32 includes a transaction commodity information table 321 provided in each supermarket 4. That is, when a plurality of supermarkets 4 are present, the transaction commodity information table is generated for each of store IDs indicating the respective supermarkets 4.

In the transaction commodity information table, a commodity ID, a price, and a stock of the commodity and a position of a shelf in the store where the commodity is displayed are set. In the transaction commodity information table, respective kinds of information of commodities sold in the store are set.

Note that the same applies to the database 33 and 34. When a plurality of the convenience stores 5 and a plurality of vending machines 6 are present, transaction commodity information tables 331 and 341 are provided to correspond to the respective convenience stores 5 and the respective vending machines 6.

### Configuration of the Behavior Supporting Apparatus

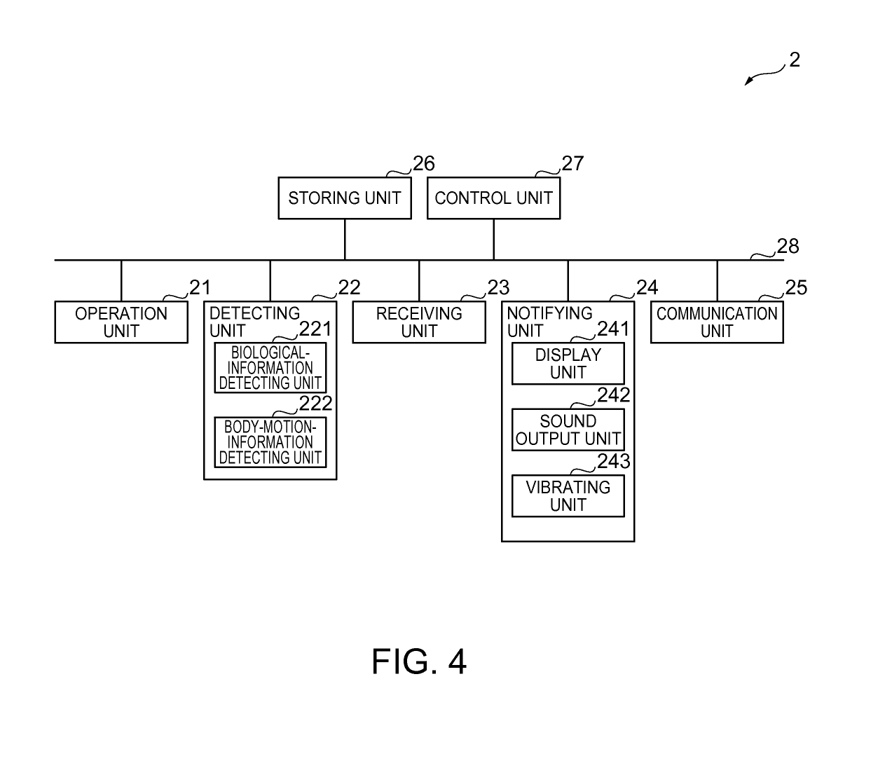

FIG. 4 is a block diagram showing the configuration of the behavior supporting apparatus 2.

The behavior supporting apparatus 2 is equivalent to the detecting apparatus according to the invention and is a wearable apparatus that is worn by the user and detects the biological information and the body motion information. The behavior supporting apparatus 2 proposes, on the basis of detected biological information, body motion information, and user information, behavior corresponding to a potential desire of the user and supports the behavior.

The behavior supporting apparatus 2 includes, as shown in FIG. 4, an operation unit 21, a detecting unit 22, a receiving unit 23, a notifying unit 24, a communication unit 25, a storing unit 26, and a control unit 27. The units 21 to 27 are electrically connected by a bus 28.

### Configuration of the Operation Unit

The operation unit 21 receives input operation by the user and outputs operation information corresponding to the input operation to the control unit 27. The operation unit 21 can be configured by, for example, physical keys and a touch panel provided on a housing of the behavior supporting apparatus 2. Note that the behavior supporting apparatus 2 may detect tap operation of the user as input operation.

### Configuration of the Detecting Unit

The detecting unit 22 includes a biological-information detecting unit 221 and a body-motion-information detecting unit 222 that respectively detect biological information and body motion information of the user.

The biological-information detecting unit 221 detects biological information of the user wearing the behavior supporting apparatus 2. In this embodiment, the biological-information detecting unit 221 detects a pulse wave and a blood sugar level serving as the biological information. However, the biological-information detecting unit 221 may detect other kinds of biological information such as a blood pressure, a body temperature, a perspiration amount, and a state of pupils.

The body-motion-information detecting unit 222 detects, as the body motion information of the user, acceleration that changes according to a body motion of the user.

### Configuration of the Receiving Unit

In this embodiment, the receiving unit 23 is equivalent to the position-information acquiring unit according to the invention. In this embodiment, the receiving unit 23 is configured by a GPS (Global Positioning System) receiving circuit and receives a satellite signal transmitted from a position information satellite. The receiving unit 23 acquires position information of the user (the behavior supporting apparatus 2) from the acquired satellite signal and outputs the acquired position information to the control unit 27.

### Configuration of the Notifying Unit

The notifying unit 24 notifies various kinds of information under the control by the control unit 27. The notifying unit 24 notifies, for example, an operation state of the behavior supporting apparatus 2 and detected information. As explained in detail below, the notifying unit 24 notifies the present state of the user and content of behavior that satisfies a potential desire of the user estimated on the basis of the state. That is, the notifying unit 24 presents behavior generated by a proposal-information generating unit 281 explained below. The notifying unit 24 includes a display unit 241, a sound output unit 242, and a vibrating unit 243.

The display unit 241 has an information display function of liquid crystal or the like and displays the various kinds of information.

The sound output unit 242 includes a speaker and outputs sound corresponding to sound information input from the control unit 27.

The vibrating unit 243 includes a motor controlled to be driven by the control unit 27 and notifies a state of the behavior supporting apparatus 2 with vibration generated by the driving of the motor.

### Configuration of the Communication Unit

The communication unit 25 includes a communication module capable of communicating with the server 3 via the network N. The communication unit 25 communicates with the server 3 and acquires various kinds of information from the server 3, for example, under the control by the control unit 27. Note that, in this embodiment, the communication unit 25 communicates by radio with a base station and a connection apparatus (e.g., a router) connected to the network N to thereby be communicably connected to an external apparatus.

### Configuration of the Storing Unit

The storing unit 26 is configured by a nonvolatile semiconductor memory such as a flash memory and has stored therein computer programs and data necessary for the operation of the behavior supporting apparatus 2.

The storing unit 26 has stored therein in advance, for example, as the data, connection information for connection to the server 3 for communication via the communication unit 25, a table in which, for each of states of the user, means for relieving the user of the state is associated, and various kinds of map information. The storing unit 26 stores detection information (biological information, body motion information, and position information) detected by the detecting unit 22 and user information including a behavior history acquired by a user-information acquiring unit 276 explained below.

For example, the storing unit 26 includes, as the computer programs, a notification control program for executing notification control processing for notifying a state of the user and a behavior presentation control program for executing behavior presentation processing for causing the display unit 241 to display behavior that satisfies a desire of the user.

### Configuration of the Control Unit

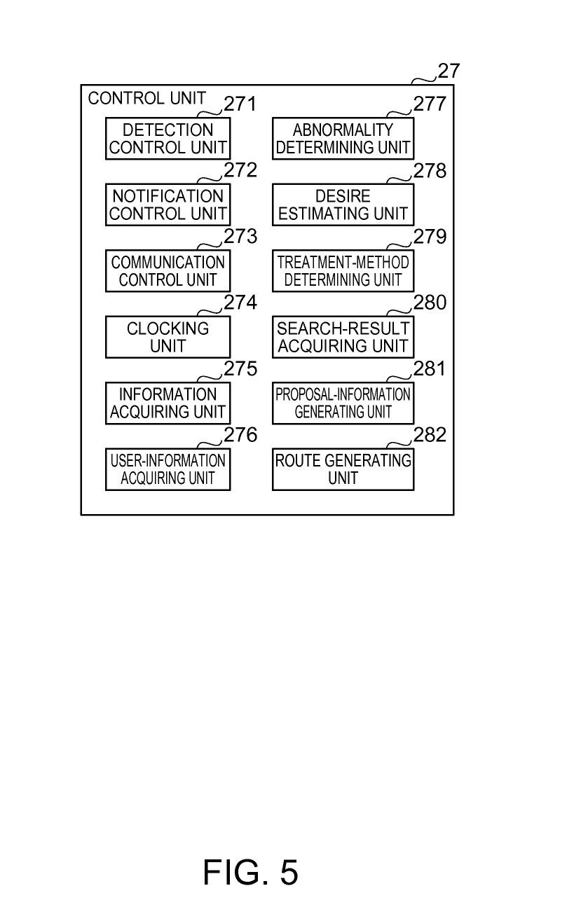

FIG. 5 is a block diagram showing the configuration of the control unit 27.

The control unit 27 is configured by a processing circuit such as a CPU (Central Processing Unit) and controls the operation of the behavior supporting apparatus 2 autonomously or on the basis of an operation signal input from the operation unit 21 according to the operation by the user. For example, the control unit 27 analyzes biological information and body motion information detected by the detecting unit 22 and estimates a potential desire of the user on the basis of the biological information and the body motion information. The control unit 27 executes notification control processing for notifying commodity information of a service and a commodity corresponding to a state of the user and a potential desire of the user and behavior presentation processing for presenting behavior proposal information for enabling the user to enjoy the service and the commodity.

The control unit 27 includes, as functional units realized by the control circuit executing the computer programs stored in the storing unit 26, as shown in FIG. 5, a detection control unit 271, a notification control unit 272, a communication control unit 273, a clocking unit 274, an information acquiring unit 275, a user-information acquiring unit 276, an abnormality determining unit 277, a desire estimating unit 278, a treatment-method determining unit 279, a search-result acquiring unit 280, a proposal-information generating unit 281, and a route generating unit 282.

The detection control unit 271 controls the operation of the detecting unit 22 and causes the storing unit 26 to store a detection result by the detecting unit 22. In a state in which the behavior supporting apparatus 2 is worn by the user and detection of biological information and body motion information by the detecting unit 22 is possible, the detection control unit 271 causes the detecting unit 22 to detect the respective kinds of information. In a state in which the detection of the respective kinds of information by the detecting unit 22 cannot be executed, the detection control unit 271 stops the operation of the detecting unit 22. Therefore, when the behavior supporting apparatus 2 is worn by the user, the detected biological information and the detected operation information are stored in the storing unit 26. When the behavior supporting apparatus is not worn by the user, these kinds of information are not stored. Therefore, power consumption can be reduced.

The notification control unit 272 controls the operation of the notifying unit 24. For example, the notification control unit 272 controls the operation of the display unit 241 of the notifying unit 24 and causes the display unit 241 to display the information detected by the detecting unit 22. The notification control unit 272 causes the display unit 241 to display information concerning a state of the user generated by the abnormality determining unit 277 and commodity information of a commodity that satisfies a desire of the user estimated by the desire estimating unit 278. Further, when the abnormality determining unit 277 determines that biological information of the user is not within a normal range, the notification control unit 272 causes the vibrating unit 243 to operate and causes the user to notice the display content. Note that the notification control unit 272 and the treatment-method determining unit 279, the search-result acquiring unit 280, the proposal-information generating unit 281 configure the behavior presenting unit according to the invention.

Note that, in this embodiment, the notification control unit 272 causes the display unit 241 to display, as the information detected by the detecting unit 22, a blood sugar level serving as the biological information detected by the biological-information detecting unit 221. However, the notification control unit 272 is not limited to the configuration for causing the display unit 241 to display the biological information. The notification control unit 272 may cause the display unit 241 to display, instead of or in addition to the biological information, information (besides the present exercise intensity, for example, cumulative information such as the number of steps, a traveling distance, and an exercise time and achievement degrees of exercise with respect to a target time and a target distance) calculated on the basis of the acceleration information detected by the body-motion information detecting unit 222 or may not cause the display unit 241 to display the biological information.

The communication control unit 273 controls the operation of the communication unit 25 and causes, on the basis of the connection information stored in the storing unit 26, the communication unit 25 to communicate with the server 3 associated with the behavior supporting apparatus 2.

The clocking unit 274 clocks the present time. Time clocked by the clocking unit 274 is used for search conditions set by the search-result acquiring unit 280.

The information acquiring unit 275 causes the storing unit 26 to store the biological information, the body motion information, and the position information acquired by the biological-information detecting unit 221, the body-motion-information detecting unit 222, and the receiving unit 23.

The user-information acquiring unit 276 acquires user information including a behavior history of the user.

The behavior history includes history information such as “when and where the user went” and habit information such as “a running route of everyday running”. Besides, the user information includes an attribute, presence or absence of a symptom, and taste in a commodity of the user. Among the user information, the behavior history is stored in the storing unit 26 on the basis of the various kinds of information autonomously detected by the user-information acquiring unit 276 using the detecting unit 22 and the receiving unit 23. The user information other than the behavior history is input by the user operating the operation unit 21 and stored in the storing unit 26.

The abnormality determining unit 277 determines whether the blood sugar level serving as the biological information stored in the storing unit 26 by the information acquiring unit 275 is within a normal range.

As explained in detail below, the storing unit 26 has stored therein a table in which detected biological information and detected body motion information and types of abnormality estimated on the basis of the biological information and the body motion information are associated. The abnormality determining unit 277 determines whether abnormality corresponding to respective changes of the detected biological information and the detected body motion information is set in the table to thereby determine whether abnormality occurs in the user. For example, when information to the effect that the user has a hypoglycemia symptom if a blood sugar level is lower than 70 mg/dl is set in the table, if a detected blood sugar level of the user is lower than 70 mg/dl, the abnormality determining unit 277 determines that abnormality (the hypoglycemia symptom) occurs in the user.

The desire estimating unit 278 estimates a potential desire of the user on the basis of detected biological information and detected body motion information. In this embodiment, the desire estimating unit 278 functions when the abnormality determining unit 277 determines that abnormality occurs in the user. The desire estimating unit 278 determines, on the basis of the biological information and the body motion information, a type of the abnormality that occurs in the user and estimates a potential desire of the user corresponding to the type. For example, when the desire estimating unit 278 determines on the basis of a blood sugar level serving as the detected biological information that a state of the user is a hypoglycemia symptom, the desire estimating unit 278 estimates a desire of the user to take sugar.

The treatment-method determining unit 279 determines a treatment method for the desire estimated by the desire estimating unit 278. Specifically, the treatment-method determining unit 279 determines a treatment method for the estimated desire referring to treatment method tables stored in the storing unit 26.

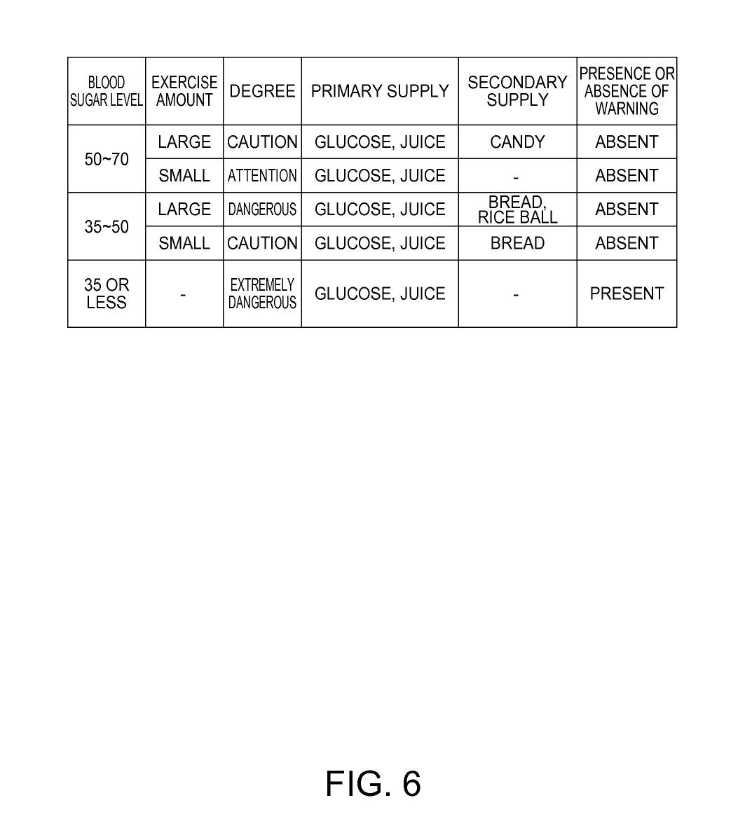

FIG. 6 is a diagram showing a hypoglycemia treatment table stored in the storing unit 26.

The treatment method table referred to by the treatment-method determining unit 279 is explained.

As explained above, the storing unit 26 has stored therein a plurality of treatment method tables in which treatment methods corresponding to desires of the user are set. In the treatment method tables, the treatment methods for desires are set according to detailed states of the user.

Specifically, among the treatment method tables, in the hypoglycemia treatment table referred to when a state of the user is a hypoglycemia symptom and a desire of the user to take sugar is estimated, as shown in FIG. 6, states of the user (i.e., blood sugar levels and exercise amounts of the user) and means for relieving the user of the hypoglycemia symptom (e.g., a commodity that should be acquired) are set in association with each other. The contents of the hypoglycemia treatment table are created from a medical viewpoint and a nutrition science viewpoint. Note that determination of an exercise amount is performed on the basis of a pulse rate calculated from a detected pulse wave serving as biological information and body motion information.

In the hypoglycemia treatment table, a numerical value range of a blood sugar level, an exercise amount, a degree of danger based on the blood sugar level and the exercise amount, a primary supply, a secondary supply, and presence or absence of a warning are set as items.

Among these items, the primary supply is a supply desired to be immediately acquired. The secondary supply is a supply desired to be acquired together with the primary supply. The presence or absence of a warning is an item indicating necessity of outputting a warning to the user.

In such a hypoglycemia treatment table, for example, in a row in which the blood sugar level is equal to or higher than 50 mg/dl and lower than 70 mg/dl and the exercise amount is large, “caution” is set in the degree of danger, “glucose, juice” is set in the primary supply, “candy” is set in the secondary supply, and “absent” is set in the presence or absence of a warning.

In a row in which the blood sugar level is equal to or higher than 50 mg/dl and lower than 70 mg/dl and the exercise amount is small, “attention” is set in the degree of danger, “glucose, juice” is set in the primary supply, “—(not applicable)” is set in the secondary supply, and “absent” is set in the presence or absence of a warning.

Further, in a row in which the blood sugar level is equal to or higher than 35 mg/dl and lower than 50 mg/dl and the exercise amount is large, “dangerous” is set in the degree of danger, “glucose, juice” is set in the primary supply, “bread, rice ball” is set in the secondary supply, and “absent” is set in the presence or absence of a warning. On the other hand, in a row in which the blood sugar level is equal to or higher than 35 mg/dl and lower than 50 mg/dl and the exercise amount is small, “caution” is set in the degree of danger, “glucose, juice” is set in the primary supply, “bread” is set in the secondary supply, and “absent” is set in the presence or absence of a warning.

In addition, in a row in which the blood sugar level is lower than 35 mg/dl, irrespective of the exercise amount, “extremely dangerous” is set in the degree of danger, “glucose, juice” is set in the primary supply, “—(not applicable)” is set in the secondary supply, and “present” is set in the presence or absence of a warning.

The presence or absence of a warning is explained. In the hypoglycemia treatment table, when the presence or absence of a warning is “present”, the treatment-method determining unit 279 displays a warning sentence such as “immediately go to a medical institution” or “ask people around for help” on the display unit 241, outputs warning sound from the sound output unit 242, and vibrates the vibrating unit 243.

When a state of the user is a hypoglycemia symptom and a desire of the user to take sugar is estimated, the treatment-method determining unit 279 acquires, from the hypoglycemia treatment table included in the treatment method table, information concerning the primary supply and the secondary supply corresponding to the state of the user and determines acquisition of the primary supply and the secondary supply as a treatment method for the hypoglycemia symptom.

The search-result acquiring unit 280 sets search conditions on the basis of the treatment method determined by the treatment-method determining unit 279, the position of the user acquired by the information acquiring unit 275, and the user information acquired by the user-information acquiring unit 276 and transmits the search conditions to the server 3 via the communication unit 25. After a search for article information of the primary supply and the secondary supply corresponding to the search conditions is performed in the server 3, the search-result acquiring unit 280 acquires a result of the search from the server 3. Note that the search-result acquiring unit 280 is equivalent to the article-information acquiring unit and the place-information acquiring unit according to the invention.

For example, when the blood sugar level of the user is 40 mg/dl and the exercise amount of the user is large, the degree of danger is “dangerous”. In this case, first, the search-result acquiring unit 280 transmits “juice containing glucose suitable for hypoglycemia measures” to the server 3 as the search conditions. In the server 3, a commodity ID of juice that contains glucose and is “suitable” in the column of the hypoglycemia measures is acquired from the detailed information table. In this case, according to the user information, the juice may be limited to juice that is “weak” in sweetness. A commodity name, explanation, and a photograph are acquired from the content table on the basis of the commodity ID. Besides, a plurality of kinds of information concerning, among stores selling a commodity corresponding to the commodity ID, a store that is currently open and close to the present position and in which a stock of the commodity is not “0” are acquired from the store information table and the transaction commodity information table. The search-result acquiring unit 280 acquires a result of the search (information concerning the stores) performed in the server 3.

On the other hand, when information concerning a store corresponding to the search condition is not included in the search result, the search-result acquiring unit 280 expands the search conditions and executes the processing again. That is, the search-result acquiring unit 280 sets search conditions according to a state of the user shown in the hypoglycemia treatment table and acquires a search result corresponding to the search conditions from the server 3.

Consequently, a commodity “ww water” is found as “the juice containing glucose suitable for hypoglycemia measures”. Besides information concerning the commodity, a store in which a stock of the commodity is not 0 and that is close to the present position of the user is found.

The proposal-information generating unit 281 generates, on the basis of a search result acquired by the search-result acquiring unit 280, behavior proposal information for proposing behavior with which the user can enjoy the commodity that satisfies the desire of the user.

First, the proposal-information generating unit 281 generates, on the basis of information corresponding to the search conditions set by the search-result acquiring unit 280, behavior proposal information for proposing behavior that satisfies the desire of the user. Specifically, the proposal-information generating unit 281 generates information indicating a state of the user (e.g., a hypoglycemia symptom), information indicating behavior that the user should take (information indicating a commodity that the user should acquire), and information indicating a place where the commodity can be acquired.

Consequently, the proposal-information generating unit 281 generates behavior proposal information indicating that the user is likely to have a hypoglycemia symptom, a category of a commodity that the user should acquire is “juice”, a commodity suitable for improving the hypoglycemia symptom among “juice” commodities is “ww water”, and a store where the commodity can be purchased is a “store A”.

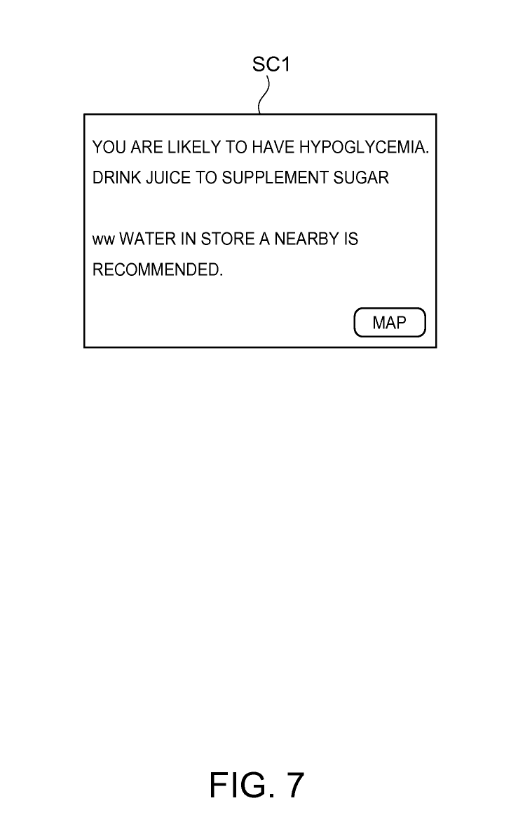

FIG. 7 is a diagram showing an example of a screen SC1 on which the behavior proposal information is presented.

As shown in FIG. 7, the notification control unit 272 causes the display unit 241 to display the screen SC1 including the behavior proposal information generated by the proposal-information generating unit 281.

A “MAP” button is disposed on the screen SC1. When the “MAP” button is pressed by the user, the notification control unit 272 causes the display unit 241 to display a route guide screen SC2 explained below.

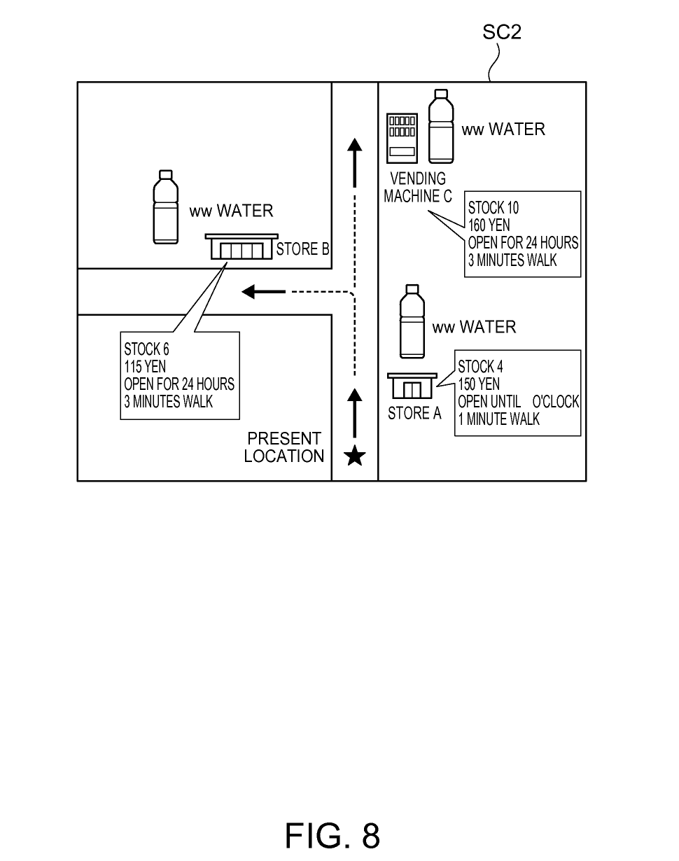

The route generating unit 282 generates a route for guiding the user from the present position to a place (e.g., the store A) indicated by the place information. The notification control unit 272 causes the display unit 241 to display, on a screen generated on the basis of the map information stored in the storing unit 26, the route guide screen SC2 (see FIG. 8) on which a route to a store selling the “ww water” corresponding to the search conditions is displayed over the map information.

FIG. 8 is a diagram showing an example of the route guide screen SC2 including commodity information of a commodity that satisfies a request of the user and a route to a store selling the commodity.

Specifically, on the route guide screen SC2 displayed by the route generating unit 282, as shown in FIG. 8, the present position of the user, the positions of stores (the store A, a store B, and a vending machine C) selling the “ww water”, opening hours of the stores, images of the “ww water”, a commodity name, stocks, prices, and required times of movement to the stores along the route are displayed. Consequently, the user can freely select, according to a state of the user, a store where the user should purchase the “ww water”.

When the user enters, for example, the store A, the route generating unit 282 detects, from the database 32 of the server 3, the position of a shelf on which the “ww water” is arrayed in the store A and generates a route to the position of the shelf on which the “ww water” is arrayed. The notification control unit 272 controls the operation of the display unit 241 and causes the display unit 241 to display a map of the store A and the generated route to thereby guide the user to the position of the shelf. Note that such a route in the store may be displayed on a display apparatus disposed in the store.

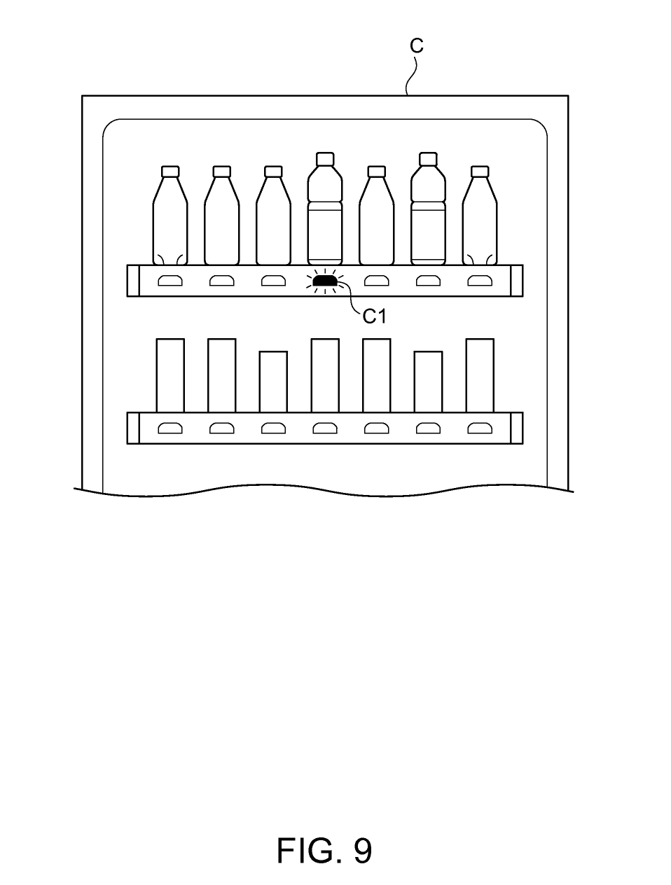

FIG. 9 is a diagram showing an example in which behavior presentation processing in the vending machine C is executed.

On the other hand, for example, when the user moves to the vicinity of the vending machine C (see FIG. 8) (more specifically, when the user is located in the front of the vending machine C), a not-shown communication unit provided in the vending machine C communicates with the communication unit 25 of the behavior supporting apparatus 2 and a not-shown control unit in the vending machine C causes a purchase button C1 for the “ww water” to blink. Specifically, the control unit of the vending machine C acquires proposal information from the behavior supporting apparatus 2 via the communication unit, collates a commodity list of the vending machine C and the proposal information, and, when the same commodity or a similar commodity is extracted, performs processing for notifying the user of a button or the like for purchasing the extracted commodity. Consequently, the user can easily discriminate the button for the “ww water”. The user can easily recognize that the user can obtain the “ww water” by inputting cash into the vending machine C and pressing the purchase button C1.

The treatment-method determining unit 279, the search-result acquiring unit 280, the proposal-information generating unit 281, the notification control unit 272, and the notifying unit 24 explained above are equivalent to the behavior presenting unit according to the invention.

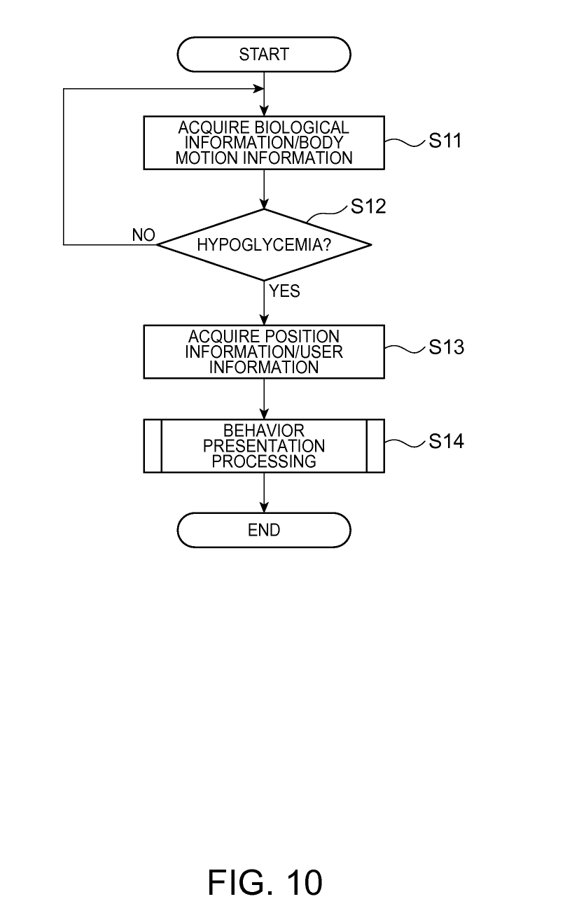

FIG. 10 is a flowchart for explaining notification control processing.

The control unit 27 executes the notification control processing explained below on the basis of a computer program stored in the storing unit 26. The notification control processing is processing for presenting (notifying), on the display unit 241 configuring the notifying unit 24, on the basis of the biological information, the body motion information, and the user information detected by the detecting unit 22, the user with a potential desire of the user and behavior proposal information for proposing behavior that satisfies the desire.

In the notification control processing, as shown in FIG. 10, the biological-information detecting unit 221 and the body-motion-information detecting unit 222 of the detecting unit 22 detect biological information and body motion information of the user and the information acquiring unit 275 causes the storing unit 26 to store these kinds of information (step S11).

Thereafter, the abnormality determining unit 277 determines, on the basis of a table (in this case, the hypoglycemia treatment table) in which the biological information and the body motion information detected in step S11 and a type of abnormality estimated on the basis of the biological information and the body motion information are associated, whether a hypoglycemia symptom occurs in the user (step S12). That is, determination processing in step S12 is equivalent to the processing for determining whether the biological information (the blood sugar level) of the user is within the normal range.

When it is determined in the determination processing in step S13 that the hypoglycemia symptom does not occur in the user, the control unit 27 returns the processing to step S11.

On the other hand, when it is determined in the determination processing in step S12 that the hypoglycemia symptom occurs in the user, the user-information acquiring unit 276 acquires position information acquired by the receiving unit 23 and user information of the user (step S13).

After step S13, the control unit 27 executes behavior presentation processing S14.

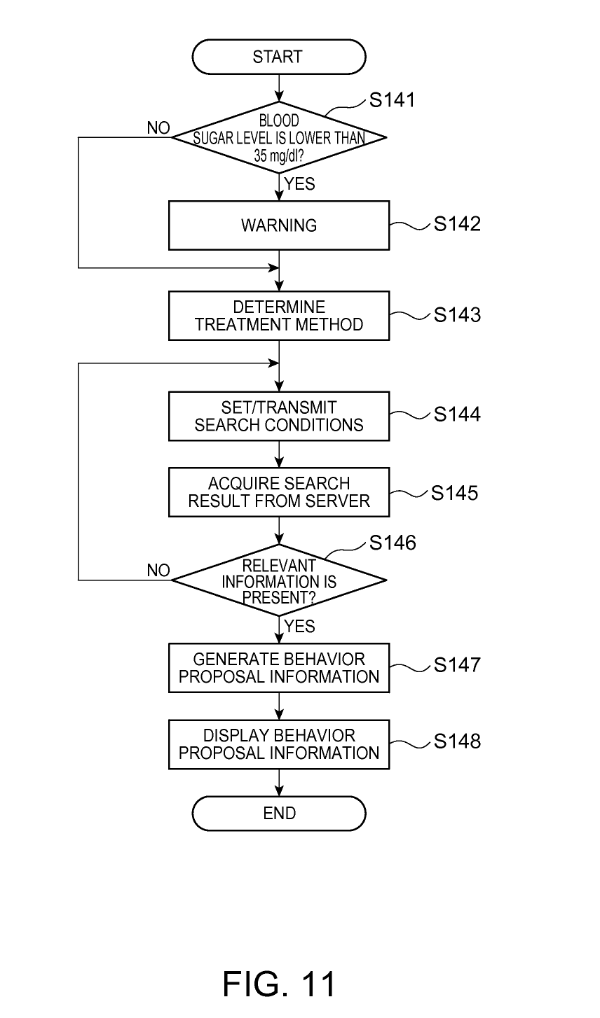

FIG. 11 is a flowchart for explaining the behavior presentation processing S14 in the notification control processing.

The control unit 27 executes the behavior presentation processing S14 on the basis of a computer program stored in the storing unit 26. The behavior presentation processing S14 is processing for presenting behavior for relieving the user of a hypoglycemia symptom and supporting the behavior.

In the behavior presentation processing S14, as shown in FIG. 11, first, the abnormality determining unit 277 determines whether a blood sugar level of the user is lower than 35 mg/dl (step S141).

When it is determined in determination processing in step S141 that the blood sugar level of the user is lower than 35 mg/dl, the notification control unit 272 controls the operation of the notifying unit 24 to execute a warning (step S142). Thereafter, the control unit 27 shifts the processing to step S143.

On the other hand, when it is determined in the determination processing in step S141 that the blood sugar level of the user is not lower than 35 mg/dl, the control unit 27 also shifts the processing to step S143.

In step S143, since a hypoglycemia symptom occurs in the user, the desire estimating unit 278 estimates a desire of the user to take sugar. In response to the desire, the treatment-method determining unit 279 determines a treatment method for the hypoglycemia symptom. Specifically, the treatment-method determining unit 279 determines, as the treatment method for the hypoglycemia symptom, a method of acquiring, from the hypoglycemia treatment table included in the treatment method tables, information concerning the primary supply and the secondary supply corresponding to the state of the user and causing the user to acquire the primary supply and the secondary supply (step S143).

The search-result acquiring unit 280 sets, on the basis of the treatment method determined by the treatment-method determining unit 279, the position of the user acquired by the information acquiring unit 275, and the user information acquired by the user-information acquiring unit 276, candidates of an article that the user should acquire and search conditions for searching for a store selling the article and transmits the search conditions to the server 3 via the communication unit 25 (step S144). Consequently, article information of articles (the primary supply and the secondary supply) corresponding to the search conditions, place information of the store selling the articles, and the like are searched in the server 3.

The search-result acquiring unit 280 acquires a search result by the server 3 (step S145).

Thereafter, the control unit 27 determines on the basis of the search result whether information corresponding to the search conditions (information concerning a commodity corresponding to the search conditions and a store selling the commodity) is present (step S146).

When it is determined that information corresponding to the search conditions is not included, the control unit 27 returns to step S144, sets broader search conditions, and sends the search conditions again.

On the other hand, when it is determined by the determination in step S146 that the information corresponding to the search conditions is included, the proposal-information generating unit 281 generates, on the basis of the search result acquired by the search-result acquiring unit 280, behavior proposal information for proposing behavior with which the user can enjoy a commodity that satisfies the desire of the user (step S147). Note that, when a plurality of kinds of information corresponding to the search conditions are acquired, the proposal-information generating unit 281 generates behavior proposal information suitable for the state of the user on the basis of any one of these kinds of information.

The notification control unit 272 causes the display unit 241 to display the screen SC1 including the behavior proposal information generated by the proposal-information generating unit 281 (step S148). Note that, as explained above, when the “MAP” button is pressed on the screen SC1, the notification control unit 272 causes the display unit 241 to display the route guide screen SC2 generated by the route generating unit 282 and ends the behavior proposal processing.

Note that the articles (the primary supply and the secondary supply) that should be acquired according to a hypoglycemia symptom are set in the table. When the hypoglycemia symptom occurs in the user, the proposal-information generating unit 281 generates the behavior proposal information for recommending intake of the articles. However, not only this, but, depending on a degree of the hypoglycemia symptom, the proposal-information generating unit 281 may generate and present behavior proposal information for recommending a medical examination in a medical facility (equivalent to the service). In such a case, the behavior supporting apparatus 2 only has to acquire, for example, place information of medical facilities where a medical examination is available from the server 3 and generate and present behavior proposal information including the information.

### Effects of the First Embodiment

With the behavior supporting system 1 according to this embodiment explained above, there are effects explained below.

The desire estimating unit 278 estimates a desire of the user on the basis of biological information. The proposal-information generating unit 281 generates behavior proposal information indicating behavior with which the user can enjoy at least one of a service and a commodity corresponding to the estimated desire. The notification control unit 272 presents the behavior proposal information on the display unit 241. Consequently, it is possible to easily cause the user to recognize behavior with which the user can enjoy at least one of a service and a commodity that the user potentially desires, although not being aware of the desire. Therefore, the user can satisfy the potential desire of the user by executing the presented behavior.

When the abnormality determining unit 277 determines that biological information (a blood sugar level) of the user is not within the normal range, the desire estimating unit 278 estimates a potential desire of the user on the basis of the biological information. Consequently, for example, when it is determined that a hypoglycemia symptom in which a blood sugar level serving as biological information is low occurs, it is possible to estimate a potential desire of the user to take sugar (glucose).

Therefore, even when the user does not notice abnormality of the body, it is possible to present behavior for relieving the user of the abnormality of the body (a hypoglycemia symptom) and quickly solve an abnormal state of the body.

By estimating a potential desire of the user on the basis of not only biological information (a blood sugar level) but also body motion information (intensity of exercise), the desire estimating unit 278 can estimate the desire more in detail. For example, when it is determined that a blood sugar level detected as the biological information is relatively low and a hypoglycemia symptom occurs, it is possible to grasp a degree of the hypoglycemia symptom on the basis of intensity of exercise performed by the user. In this case, for example, when the hypoglycemia symptom is serious, it is possible to present behavior with which the user can enjoy immediately-effective sugar. Therefore, it is possible to present behavior further adapted to a state of the body of the user.

The search-result acquiring unit 280 acquires commodity information concerning a commodity corresponding to a desire of the user from the server 3 configuring the point-of-sales-information managing system. The notifying unit 24 notifies the commodity information. Consequently, it is possible to easily cause the user to recognize commodity information concerning a commodity that the user potentially desires. Therefore, it is possible to cause the user to grasp detailed information concerning the commodity.

The search-result acquiring unit 280 acquires, from the server 3 configuring the point-of-sales-information managing system, place information concerning a place (e.g., the store A) where the user can enjoy at least one of a service and a commodity necessary for the user. The acquired place information is notified to the user. Consequently, it is possible to easily cause the user to recognize a providing place (a store selling the commodity and the medial institution) where the user can enjoy at least one of a service and a commodity that the user potentially desires. Since the place information is acquired on the basis of a present position of the user, it is possible to notify the user of a store selling the commodity or a medical institution relatively close to the present position. Therefore, it is possible to improve convenience of the behavior supporting apparatus.

The route generating unit 282 generates a route to a providing place (e.g., the store A) where the user can enjoy one of a service and a commodity corresponding to a desire of the user and time required in moving along the route. The notification control unit 272 causes the notifying unit 24 to notify the route and the required time. Consequently, it is possible to easily cause the user to recognize a route to a place where the user can enjoy a service and a commodity corresponding to a desire of the user and time required in moving along the route.

The treatment method determining unit 279 determines, on the basis of the table stored in the storing unit 26, a treatment method that satisfies the desire of the user. The proposal-information generating unit 281 generates behavior proposal information corresponding to the determined treatment method. The notification control unit 272 presents the behavior proposal information. Consequently, it is possible to accurately and quickly execute presentation of the behavior proposal information with which the user can enjoy the service and the article. Therefore, it is possible to simplify processing concerning the presentation of the behavior proposal information. Besides, it is possible to quickly satisfy a potential desire of the user.

The biological-information detecting unit 221 acquires a blood sugar level and a pulse wave serving as biological information. Consequently, it is possible to estimate a desire of the user in detail and accurately on the basis of the biological information. Therefore, it is easy to surely and appropriately grasp a potential desire of the user. It is possible to appropriately present behavior that satisfies the desire.

### Second Embodiment

A second embodiment of the invention is explained.

A behavior supporting system according to this embodiment includes a configuration same as the configuration of the behavior supporting system 1. In the behavior supporting system 1, the biological-information detecting unit 221 of the behavior supporting apparatus 2 detects a pulse wave and a blood sugar level as biological information. On the other hand, in the behavior supporting system according to this embodiment, the biological-information detecting unit 221 of a behavior supporting apparatus detects, as biological information, a body temperature and a perspiration amount of a user instead of the blood sugar level.

The hypoglycemia treatment table is stored in the storing unit 26 of the behavior supporting apparatus 2. On the other hand, in a storing unit of the behavior supporting apparatus according to this embodiment, a heat stroke treatment table referred to when the user is in a heat stroke state or a feverish state and a desire of the user to take water containing salt and glucose is estimated is stored instead of or in addition to the hypoglycemia treatment table. The behavior supporting system and the behavior supporting system 1 are different in these points.

Note that, in the following explanation, components the same as or substantially the same as the components explained above are denoted by the same reference numerals and signs and explanation of the components is omitted.

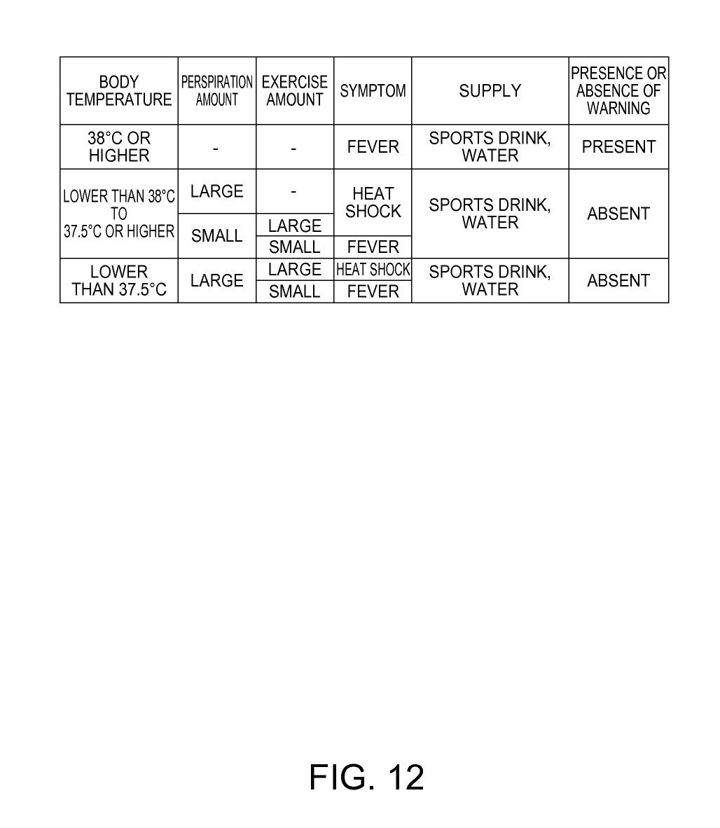

FIG. 12 is a diagram showing the heat stroke treatment table stored in the storing unit 26.

The behavior supporting system according to this embodiment includes components and functions same as the components and the functions of the behavior supporting system 1. However, as explained above, in the storing unit 26 of the behavior supporting apparatus 2, the heat stroke treatment table is stored as one of the plurality of treatment method tables.

In the heat stroke treatment table, as shown in FIG. 12, states of the user (i.e., a body temperature, a perspiration amount, and an exercise amount of the user) and means for relieving the user of a heat stroke or a feverish state (e.g., a commodity that should be acquired) are set in association with each other.

Specifically, in the heat stroke treatment table, a numerical value range of a body temperature, a perspiration amount, an exercise amount, and a symptom of the user, a supply, and presence or absence of a warning are set as items. The supply is a supply desired to be immediately acquired by the user.

In such a heat stroke treatment table, for example, in a row in which the body temperature is lower than 37.5° C., the perspiration amount is large, and the exercise amount is large, “heat stroke” is set in the symptom, “sports drink, water” is set in the supply, and “absent” is set in the presence or absence of a warning. Such contents of the heat stroke treatment table are created from a medical viewpoint and a nutrition science viewpoint.

In a row in which the body temperature is lower than 37.5° C., the perspiration amount is large, and the exercise amount is small, “fever” is set in the symptom, “sports drink, water” is set in the supply, and “absent” is set in the presence or absence of a warning.

Further, in a row in which the body temperature is equal to or higher than 37.5° C. and lower than 38° C., the perspiration amount is small, and the exercise amount is small, “fever” is set in the symptom, “sports drink, water” is set in the supply, and “absent” is set in the presence or absence of a warning. In a row in which the body temperature is equal to or higher than 37.5° C. and lower than 38° C., the perspiration amount is small, and the exercise amount is large, “heat stroke” is set in the symptom, “sports drink, water” is set in the supply, and “absent” is set in the presence or absence of a warning. On the other hand, in a row in which the body temperature is equal to or higher than 37.5° C. and lower than 38° C. and the perspiration amount is large, “heat stroke” is set in the symptom, “sports drink, water” is set in the supply, and “absent” is set in the presence or absence of a warning.

In addition, in a row in which the body temperature is equal to or higher than 38° C., “fever” is set in the symptom, “sports drink, water” is set in the supply, and “present” is set in the presence or absence of a warning.

The presence or absence of a warning in this embodiment is explained.

When a state of the body of the user corresponds to “present” concerning the presence or absence of a warning of the heat stroke treatment table, the treatment-method determining unit 279 causes the display unit 241 to display a warning sentence such as “immediately go to a medical institution” via the notification control unit 272, causes the sound output unit 242 to output warning sound, and vibrates the vibrating unit 243.

When the user is in a heat stroke symptom or a feverish state and the desire estimating unit 278 estimates a desire of the user to take water containing salt and sugar, the treatment-method determining unit 279 acquires information concerning a supply corresponding to a state of the user from the heat stroke treatment table included in the treatment method tables. The treatment-method determining unit 279 determines the acquisition of the supply as a treatment method for the heat stroke and the feverish state.

### Notification Control Processing

In this embodiment, the control unit 27 of the behavior supporting apparatus 2 executes notification control processing substantially the same as the notification control processing in the first embodiment. When it is determined that the body temperature and the perspiration amount of the user serving as the biological information are not within normal ranges, the control unit 27 executes behavior presentation processing substantially the same as the behavior presentation processing in the first embodiment.

Specifically, in the notification control processing according to this embodiment, as shown in FIG. 10, steps S11 and S12 are executed. In step S12, the abnormality determining unit 277 determines, on the basis of the table (the heat stroke treatment table) in which the biological information and the body motion information detected in step S11 and types of abnormality (a heat stroke and fever) estimated on the basis of the biological information and the body motion information are associated, whether the user is in a heat stroke symptom or a feverish state. When it is determined that the user is in the heat stroke symptom or the feverish state, the behavior presentation processing S14 is executed through step S13.

In the behavior presentation processing S14 in this embodiment, in step S141 shown in FIG. 11, the abnormality determining unit 277 determines whether the body temperature of the user is equal to or higher than 38° C. When it is determined in the determination processing that the body temperature of the user is equal to or higher than 38° C., the treatment-method determining unit 279 notifies a warning via the notification control unit 272 (step S142). Thereafter, the control unit 27 shifts the processing to step S143.

On the other hand, when it is determined in the determination processing that the body temperature of the user is not equal to or higher than 38° C., the control unit 27 also shifts the processing to step S143.

In step S143, since the state of the user is the heat stroke and the feverish state, the desire estimating unit 278 estimates a desire of the user to take salt and sugar. In response to the desire, the treatment-method determining unit 279 determines, as a treatment method for the heat stroke or the feverish state, a method of acquiring, from the heat stroke treatment table included in the treatment method tables, information concerning a supply corresponding to the state of the user and acquiring the supply (step S143).

Thereafter, the search-result acquiring unit 280 sets, on the basis of the treatment method determined by the treatment-method determining unit 279, the position of the user acquired by the information acquiring unit 275, and the user information acquired by the user-information acquiring unit 276, search conditions for searching for information concerning a supply suitable for the user and a place where the user can enjoy the supply and transmits the search conditions to the server 3 via the communication unit 25 (step S144).

The search-result acquiring unit 280 acquires a search result of the store information searched in the server 3 (step S145).

For example, when the body temperature of the user is equal to or higher than 37.5° C. and lower than 38° C. and the perspiration amount is large, “heat stroke” is doubted. In this case, first, the search-result acquiring unit 280 transmits “sports drink containing salt and glucose suitable for heat stroke measures” to the server 3 as search conditions for searching for an article that the user should take.

The server 3 acquires a commodity ID of a relevant sports drink from the detailed information table. In this case, the sports drink may be limited to sports drink that is “weak” in sweetness according to user information. The server 3 acquires a commodity name, explanation, and a photograph from the content table on the basis of the commodity ID. Besides, the server 3 acquires, from the store information table and the transaction commodity information table, information concerning, among stores selling a commodity corresponding to the commodity ID, a store that is currently open and close to the present position and in which a stock of the commodity is not “0”. In this case, when there are a plurality of relevant stores, information concerning all the stores is acquired. The server 3 transmits the acquired information to the behavior supporting apparatus 2 as a search result.

According to such search processing, for example, two commodities, i.e., “ww water” and “water of mm” are found as the “sports drink containing salt and glucose suitable for heat stroke measures”. Besides information concerning the two commodities, a store in which stocks of the two commodities are not 0 and that is close to the present position of the user is found.

After step S145, in the behavior supporting apparatus 2, the search-result acquiring unit 280 determines whether information corresponding to the search conditions (store information of a store selling the commodities) is present in the acquired search result (step S146).

When it is determined in the determination processing in step S146 that information concerning stores corresponding to the search condition is not included in the acquired search result, the search-result acquiring unit 280 expands the search conditions and executes the processing in step S144 again. That is, the search-result acquiring unit 280 resets the search conditions according to a state of the user shown in the treatment method table and acquires a search result corresponding to the search conditions from the server 3.

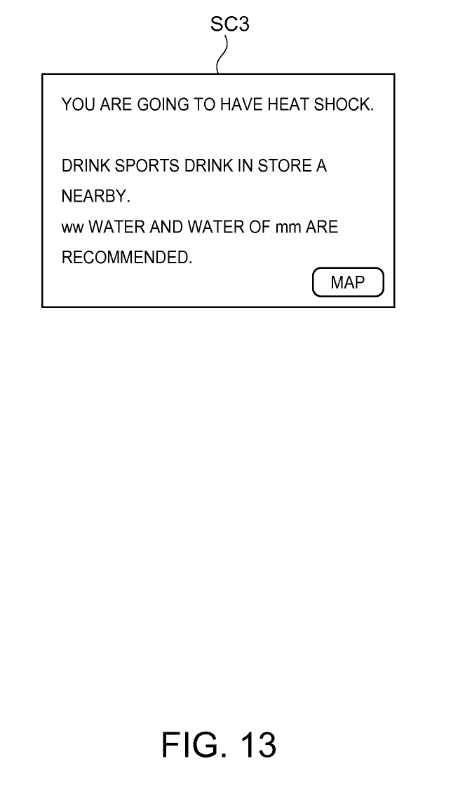

FIG. 13 is a diagram showing an example of a screen SC3 on which behavior proposal information is presented.

On the other hand, when it is determined by the determination in step S146 that information corresponding to the search conditions is included in the search result, the proposal-information generating unit 281 generates, on the basis of the acquired search result, the behavior proposal information for proposing behavior with which the user can enjoy a commodity corresponding to the desire of the user (step S147).

As shown in FIG. 13, the notification control unit 272 causes the display unit 241 to display the screen SC3 including the behavior proposal information generated by the proposal-information generating unit 281 (step S148).

For example, the proposal-information generating unit 281 generates behavior proposal information indicating that the user is likely to have a heat stroke, a category of a commodity that the user should acquire is “sports drink”, commodities suitable for improving the heat stroke symptom among “sports drink” commodities are “ww water” and “water of mm”, and a store where the commodity can be purchased is a “store A”.

As explained above, when the “MAP” button disposed on the screen SC3 is pressed, the notification control unit 272 causes the display unit 241 to display the route guide screen SC2 (see, for example, FIG. 8) generated by the route generating unit 282 and ends the behavior presentation processing.

Note that, in a screen example shown in FIG. 8, a photograph, commodity information, and the like of the “ww water” are displayed on the route guide screen SC2. However, a photograph and commodity information of the “water of mm” may be simultaneously displayed. Every time the photograph and the commodity information of the displayed commodity are pressed by the user, the photographs and the commodity information of the “ww water” and the “water of mm” may be alternately displayed on the display unit 241.

In the heat stroke treatment table, the supply that should be acquired according to a heat stroke and a fever symptom is set. When the symptom occurs in the user, the proposal-information generating unit 281 generates the behavior proposal information for recommending intake of the supply. However, not only this, but, as explained above, depending on a degree of the symptom, the proposal-information generating unit 281 may generate and present behavior proposal information for recommending a medical examination in a medical facility (equivalent to the service).

### Effects of the Second Embodiment

With the behavior supporting system according to this embodiment explained above, it is possible to attain effects same as the effects of the behavior supporting system 1. Besides, it is possible to attain effects explained below.

When the abnormality determining unit 277 determines that biological information of the user (a body temperature and a perspiration amount of the user) is not within the normal ranges, the desire estimating unit 278 estimates a potential desire of the user on the basis of the biological information. Consequently, when it is determined that the body temperature and the perspiration amount serving as the biological information are large, it is possible to estimate a potential desire of the user to take sports drink containing salt and glucose.

Therefore, even when the user does not notice abnormality of the body, it is possible to present behavior for relieving the user of the abnormality of the body (a heat stroke symptom and a feverish state) and quickly solve an abnormal state of the body.

When the desire estimating unit 278 estimates a potential desire of the user on the basis of not only the biological information (the body temperature and the perspiration amount of the user) but also body motion information (an exercise amount), it is possible to estimate the desire more in detail. For example, when the body temperature detected as the biological information is high and the perspiration amount detected as the biological information is relatively large, it is determined that a heat stroke symptom or a fever symptom occurs. An exercise amount carried out by the user is further determined. Consequently, it is possible to grasp degrees of these symptoms more in detail.

As the biological information, a pulse wave, a body temperature, and a perspiration amount are detected. Degrees of a heat stroke and a fever symptom are grasped using, as an index, an exercise amount calculated from the pulse wave and the body motion information in addition to the body temperature and the perspiration amount. If a pulse calculated from the pulse wave and the body temperature are high and the perspiration amount is large, a symptom of a heat stroke is doubted. Therefore, the desire estimating unit 278 can appropriately estimate, on the basis of the biological information and the body motion information, a desire of the user to take water containing salt and glucose. Therefore, it is possible to surely and easily grasp a potential desire of the user. It is possible to appropriately present behavior that satisfies the desire.

Note that, in this embodiment, the detecting unit 22 includes the biological-information detecting unit 221 and the body-motion-information detecting unit 222. However, not only this, but the biological-information detecting unit 221 may be omitted. In this case, for example, the abnormality determining unit 277 may be configured to determine a heat stroke risk referring to WBGT (Wet Bulb Globe Temperature) and perform abnormality determination on the basis of a result of the determination and the body motion information. Specifically, when determining that the user carries out vigorous exercise or exercise for a long time (e.g., exercise for one hour or more) under an environment with the WBGT of 30° C. corresponding to the present location of the user acquired by a GPS or the like and indicated by WBGT information acquired from an external server, the abnormality determining unit 277 may determine that the user is in an abnormal state.

### Third Embodiment

A third embodiment of the invention is explained.

A behavior supporting system according to this embodiment includes a configuration same as the configuration of the behavior supporting system 1. In the behavior supporting system 1, the biological-information detecting unit 221 of the behavior supporting apparatus 2 detects a pulse wave and a blood sugar level as biological information. On the other hand, in the behavior supporting system according to this embodiment, the biological-information detecting unit 221 of a behavior supporting apparatus detects a state of the pupils of the user instead of the blood sugar level. Therefore, the behavior supporting apparatus according to this embodiment includes an apparatus main body that detects a pulse wave and a detecting apparatus that detects a state of the pupils. Specifically, in the behavior supporting apparatus according to this embodiment, the detecting apparatus includes an image pickup apparatus that picks up a state of the pupils, more specifically, an HMD (Head Mounted Display) including a sensor that detects, the state of the pupils, that is, the number of times of blinking per one minute. The apparatus main body and the HMD are communicably connected by a radio line. Information concerning the state of the pupils detected by the HMD is transmitted to the apparatus main body.

Note that, in this embodiment, only the biological information is detected. Therefore, the behavior supporting apparatus does not include the body-motion-information detecting unit 222. However, the behavior supporting apparatus may include the body-motion-information detecting unit 222.

In the storing unit 26 of the behavior supporting apparatus 2, the hypoglycemia treatment table referred to when a hypoglycemia symptom occurs and the heat stroke treatment table referred to when a heat stroke symptom and a fever symptom occur are stored. On the other hand, in the behavior supporting apparatus according to this embodiment, the treatment-method determining unit 279 determines, without referring to the treatment method tables, a treatment method taken when the number of times of blinking and the pulse rate of the user are not within normal ranges and a desire of the user to sleep is estimated.

Further, in the behavior supporting apparatus according to this embodiment, the communication unit 25 is configured to be connectable to an external apparatus (e.g., a navigation apparatus mounted on a vehicle or the like) owned by the user. The behavior supporting system according to this embodiment and the behavior supporting system 1 are different in these points.

Note that, in the following explanation, components the same as or substantially the same as the components explained above are denoted by the same reference numerals and signs and explanation of the components is omitted.

### Notification Control Processing

The control unit 27 of the behavior supporting apparatus according to this embodiment executes notification control processing same as the notification control processing in the first and second embodiments. When it is determined that a pulse (in a broad sense, synonymous with a heartbeat) and a state of the pupils serving as biological information are not within normal ranges, behavior presentation processing same as the behavior presentation processing in the first and second embodiments is executed.

Specifically, in the notification control processing, as shown in FIG. 10, steps S11 and S12 are executed. In step S12, the abnormality determining unit 277 determines whether the number of times of blinking and the pulse rate of the user detected in step S11 are within the normal ranges. When it is determined that the number of times of blinking and the pulse rate of the user are not within the normal ranges, the behavior presentation processing S14 is executed through step S13.

In the behavior presentation processing S14 in this embodiment, the treatment-method determining unit 279 does not execute step S141 and step S142 shown in FIG. 11. The processing is executed from step S143. That is, in this embodiment, the warning processing is not executed.

In step S143, since a sleep desire of the user is high on the basis of the number of times of blinking and the pulse rate of the user, the desire estimating unit 278 estimates a desire of the user to sleep. In response to the desire, the treatment-method determining unit 279 determines, as a treatment method for a state of the high sleep desire, a method of causing the user to acquire (take) a supply (e.g., beverage containing caffeine) for solving the state of the high sleep desire of the user (step S143).

Thereafter, the search-result acquiring unit 280 sets, on the basis of the treatment method determined by the treatment-method determining unit 279, the position of the user acquired by the information acquiring unit 275, and the user information acquired by the user-information acquiring unit 276, search conditions for searching for information concerning a supply suitable for the user and a place where the user can enjoy the supply and transmits the search conditions to the server 3 via the communication unit 25 (step S144).

For example, the search-result acquiring unit 280 transmits, as the search conditions, “beverage containing caffeine for solving a state of a high sleep desire” to the server 3.

The server 3 acquires a commodity ID of the beverage containing caffeine from the detailed information table. In this case, the beverage may be limited to beverage having “strong” sweetness according to the user information. For example, when the user does not like coffee, the beverage may be limited to beverage other than coffee. The server 3 acquires a commodity name, explanation, and a photograph from the content table on the basis of the acquired commodity ID.

Further, the server 3 acquires, on the basis of the present position of the user, from the store information table and the transaction commodity information table, information concerning a store that is currently open and close to the present position and in which a stock of the commodity is not “0” among stores selling a commodity corresponding to the commodity ID.

For example, when moving speed of the user exceeds 80 km/h, it is estimated from position information and a history of the position information of the user that the user is driving on a freeway. Therefore, the server 3 acquires, as a store selling the commodity, from the store information table and the transaction commodity information table, information concerning a store that is currently open and located in a parking area of the freeway close to the present position and in which a stock of the commodity is not “0”.

Note that, when there are a plurality of relevant stores, information concerning all the stores is acquired.

The server 3 transmits the acquired information to the behavior supporting apparatus 2 as a search result.

According to such search processing, “kk tea” is found as the “beverage containing caffeine suitable for a state of a high sleep desire”. Besides, information concerning the “kk tea”, a store selling the “kk tea” in which a stock of the “kk tea” is not 0 and that is close to the present position of the user is found.

The search-result acquiring unit 280 acquires a search result of the store information searched in the server 3 (step S145) and determines whether the acquired search result includes information (store information) corresponding to the search conditions (step S146).

When it is determined in determination processing in step S146 that information concerning the store corresponding to the search conditions is not included, the search-result acquiring unit 280 expands the search conditions and executes the processing in step S144 again. That is, the search-result acquiring unit 280 resets the search conditions according to a state of the user and acquires a search result corresponding to the search conditions from the server 3.

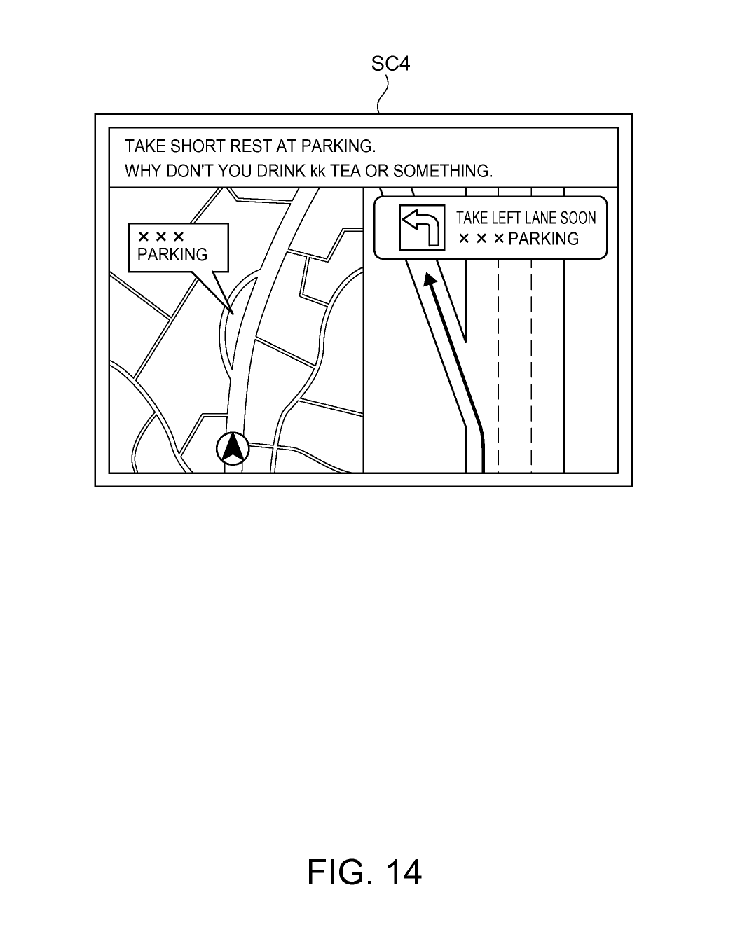

FIG. 14 is a diagram showing an example of a screen SC4 on which behavior proposal information is presented.

On the other hand, when it is determined by the determination in step S146 that information corresponding to the search conditions is included in the search result, the proposal-information generating unit 281 generates, on the basis of the acquired search result, the behavior proposal information for proposing behavior with which the user can enjoy a commodity that satisfies the desire of the user (step S147).

In step S148, the notification control unit 272 causes a display section of a not-shown navigation apparatus to present a screen including the generated behavior proposal information. For example, as shown in FIG. 14, the notification control unit 272 communicates with the not-shown navigation apparatus via the communication unit 25 and causes the display unit of the navigation apparatus to display the screen SC4 including the behavior proposal information.

Specifically, the proposal-information generating unit 281 causes the display unit to display the screen SC4 that indicates that a commodity that the user should acquire is the “kk tea” and a parking where a store (a vending machine) in which the “kk tea” can be purchased is set is a “XXX parking”. On the display unit, as shown in FIG. 14, a navigation screen for guiding the user to a destination is displayed. Therefore, the behavior proposal information is displayed in a range in which the display of the navigation screen is not prevented.

Although not shown in the figure, when the user arrives at the XXX parking, the notification control unit 272 causes the display unit 241 of the behavior supporting apparatus 2 to display a route guide screen in the XXX parking generated by the route generating unit 282. Further, when the user is located near the vending machine, as shown in FIG. 9, a control unit of the vending machine executes the processing, causes a purchase button for the “kk tea” to blink, and ends the behavior presentation processing.

### Effects of the Third Embodiment

With the behavior supporting system according to this embodiment explained above, it is possible to attain effects same as the effects of the behavior supporting system 1. Besides, it is possible to attain effects explained below.

When the abnormality determining unit 277 determines that biological information (a pulse and a state of the pupils) of the user is not within the normal ranges, the desire estimating unit 278 estimates a potential desire of the user on the basis of the biological information. Consequently, when it is determined that the heartbeat serving as the biological information is low and the number of times of blinking serving as the biological information is small, it is possible to estimate a potential desire of the user to acquire a commodity containing caffeine.

Therefore, even when the user does not notice abnormality of the body (a state of a high sleep desire), it is possible to present behavior for relieving the user of the abnormality of the body and quickly solve an abnormal state of the body.

In the state of the high sleep desire of the user, usually, drinking of coffee is presented. However, it is also likely that the user does not like coffee.

On the other hand, when behavior corresponding to a desire of the user is presented, besides biological information, user information concerning the user (in this case, taste in food of the user) is also referred to. Consequently, for example, if the user usually does not drink coffee at all, it is possible to present drinking of another beverage (e.g., tea) containing caffeine instead of coffee. Therefore, it is possible to present behavior corresponding to a need of the user.

Since a pulse and a state of the pupils are acquired as biological information, the desire estimating unit 278 can estimate, on the basis of the biological information, in detail and accurately, a desire of the user to sleep. For example, as explained above, if the heartbeat is low and the movement of the pupils is small, the desire estimating unit 278 can estimate that the user desires to sleep. Therefore, it is possible to surely, easily, and appropriately grasp a potential desire of the user. It is possible to appropriately present behavior that satisfies the desire.

In this embodiment, the screen SC4 including the behavior proposal information generated by the proposal-information generating unit 281 is displayed on the display unit of the not-shown car navigation apparatus mounted on the vehicle of the user. Therefore, the user can easily recognize the behavior proposal information (behavior that the user should take) simply by viewing the display unit of the car navigation apparatus.

### Fourth Embodiment

A fourth embodiment of the invention is explained.

### Overview of a Behavior Supporting System

A behavior supporting system according to this embodiment includes, as shown in FIG. 1, a behavior supporting apparatus A2 used by a user and the server 3 capable of communicating with the behavior supporting apparatus A2 via the network N. In the behavior supporting system, as explained in detail below, the behavior supporting apparatus A2 determines on the basis of biological information, body motion information, and user information of the user whether the user has a problem in carrying out desired behavior that the user desires to carry out (behavior with which the user can enjoy a service and a commodity desired by the user). When determining that the user has a problem in carrying out the desired behavior, the behavior supporting apparatus A2 presents behavior conforming to the desired behavior, i.e., alternative behavior that the user is determined on the basis of the biological information as having no problem in carrying out. In this case, when presenting behavior for acquiring an article, the behavior supporting apparatus A2 acquires information concerning the article from the server 3 and presents the information. Besides, the behavior supporting apparatus A2 presents a route and a required time to a place (e.g., a store or a vending machine) where an article and a service are provided.

Note that, since the configuration of the behavior supporting system is the same as the configuration of the explanation of the configuration is omitted.

### Configuration of the Behavior Supporting Apparatus

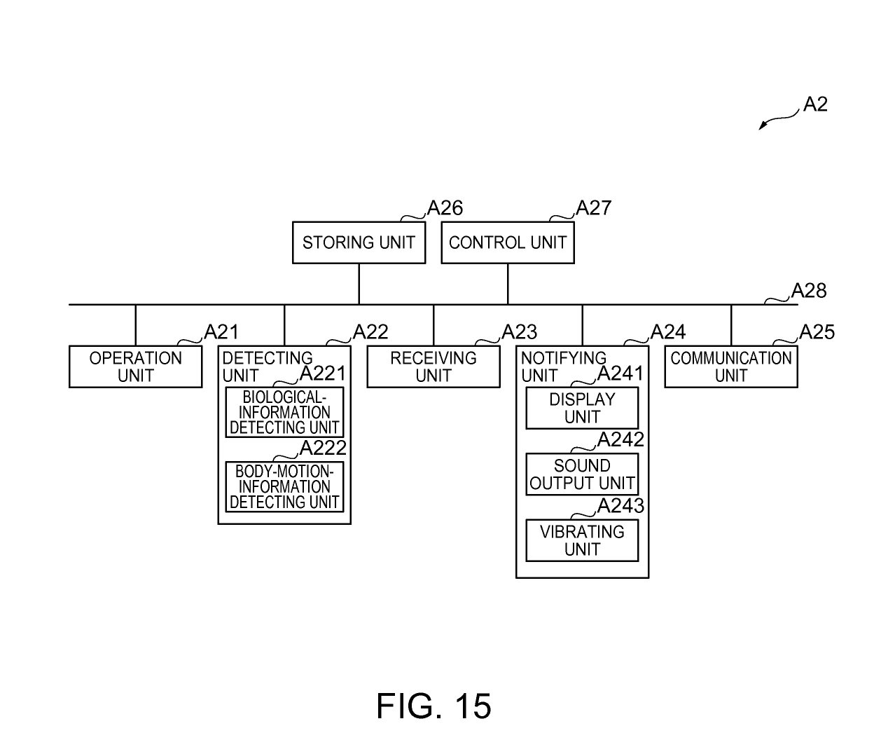

FIG. 15 is a block diagram showing the configuration of the behavior supporting apparatus A2.

The behavior supporting apparatus A2 is equivalent to the detecting apparatus according to the invention and is a wearable apparatus that is worn by the user and detects the biological information and the body motion information. The behavior supporting apparatus A2 proposes and presents, on the basis of the detected biological information and the detected body motion information and user information, which is information concerning the user, behavior that the user should take.

The behavior supporting apparatus A2 includes, as shown in FIG. 4, an operation unit A21, a detecting unit A22, a receiving unit A23, a notifying unit A24, a communication unit A25, a storing unit A26, and a control unit A27. The units A21 to A27 are electrically connected by a bus line A28.

### Configuration of the Operation Unit

The operation unit A21 receives input operation by the user and outputs an operation signal corresponding to the input operation to the control unit A27. The operation unit A21 is equivalent to the input unit according to the invention and can be configured by, for example, physical keys and a touch panel provided on a housing of the behavior supporting apparatus A2. Note that the operation unit A21 may be configured to output an operation signal corresponding to tap operation of the user to the control unit A27 or may be configured to recognize sound (voice of the user) and output an operation signal corresponding to the sound to the control unit A27.

As explained in detail below, the user operates the operation unit A21 and inputs desired behavior, which the user desires to execute, to the behavior supporting apparatus A2. This input operation also includes selection operation with which the user selects desired behavior from a selection screen displayed on a display unit A241 explained below.

### Configuration of the Detecting Unit

The detecting unit A22 includes a biological-information detecting unit A221 and a body-motion-information detecting unit A222 that respectively detect biological information and body motion information of the user.

The biological-information detecting unit A221 detects biological information of the user wearing the behavior supporting apparatus A2. In this embodiment, the biological-information detecting unit A221 detects, with various sensors, a pulse wave, a heartbeat, a blood pressure, a body temperature, a blood sugar level, a perspiration amount, and blood alcohol concentration serving as biological information. However, the biological-information detecting unit A221 may be configured to detect the body temperature and other kinds of biological information such as an electrocardiogram.

The body-motion-information detecting unit A222 detects, as body motion information of the user, acceleration that changes according to a body motion of the user.

### Configuration of the Receiving Unit

The receiving unit A23 is equivalent to the position-information acquiring unit that acquires position information of the present position of the behavior supporting apparatus A2 (i.e., position information indicating the present position of the user). For example, the receiving unit A23 corresponds to a satellite positioning system such as a GPS (Global Positioning System). The receiving unit A23 acquires position information indicating the present position on the basis of a radio wave received from a satellite. The receiving unit A23 outputs the acquired position information to the control unit A27. Note that, instead of such a configuration, the receiving unit A23 can also be configured to calculate position information using a radio wave for communication.

### Configuration of the Notifying Unit

The notifying unit A24 notifies various kinds of information under the control by the control unit A27. For example, the notifying unit A24 notifies an operation state of the behavior supporting apparatus A2 and detected information. As explained in detail below, the notifying unit A24 notifies the present state of the user and one of the desired behavior and the alternative behavior. That is, the notifying unit A24 presents behavior generated by a presentation-information generating unit A280 explained below and configures the behavior presenting unit according to the invention.

The notifying unit A24 includes a display unit A241, a sound output unit A242, and a vibrating unit A243.

The display unit A241 includes an information display function of liquid crystal or the like and displays the various kinds of information. The display unit A241 displays, for example, a user information input screen for causing the user to input user information, which is information concerning the user, and a desired behavior input screen for causing the user to input desired behavior that the user desires to carry out.

The sound output unit A242 includes a speaker and outputs sound corresponding to sound information input from the control unit A27.

The vibrating unit A243 includes a motor controlled to be driven by the control unit A27 and notifies a state of the behavior supporting apparatus A2 with vibration generated by the driving of the motor.

### Configuration of the Communication Unit

The communication unit A25 includes a communication module capable of communicating with the server 3 via the network N under the control by the control unit A27. For example, the communication unit A25 communicates with the server 3 and acquires various kinds of information from the server 3. Note that, in this embodiment, the communication unit A25 communicates, by radio, with a base station and a connection apparatus (e.g., a router) connected to the network N. Consequently, the communication unit A25 is connected to the server 3 for communication. However, a connection form and a connection mode may be any form and any mode as long as the communication unit A25 is capable of communicating with the server 3.

### Configuration of the Storing Unit

The storing unit A26 is configured by a storage device including a flash memory and has stored therein computer programs and data necessary for the operation of the behavior supporting apparatus A2.

The storing unit A26 has stored therein in advance, for example, as the data, connection information for connection to the server 3 for communication via the communication unit A25 and various kinds of map information.

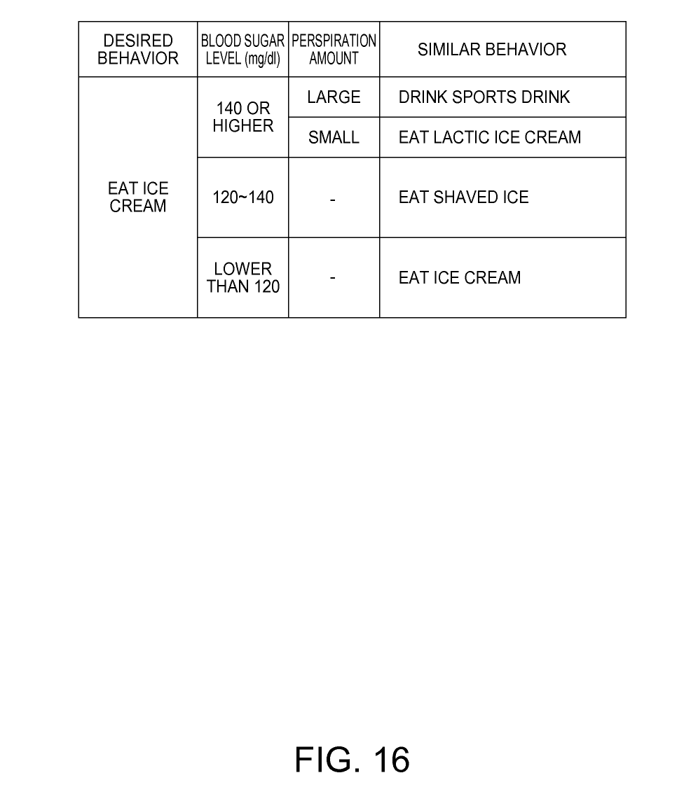

FIGS. 16 to 18 are diagrams showing examples of determination tables.

In the storing unit A26, a plurality of determination tables in which alternative behavior similar to desired behavior corresponding to biological information (a blood sugar level and a perspiration amount) and an exercise amount of the user is set are stored. In the determination tables, alternative behavior for desired behavior is set according to detailed states of the user.

For example, the determination table shown in FIG. 16 is a sugar intake determination table referred to when the desired behavior is “eat an ice cream”. In the sugar intake determination table, as shown in FIG. 16, states of the user (i.e., a blood sugar level and a perspiration amount of the user), alternative behavior (e.g., behavior with which the user can enjoy a commodity suitable for the user), and the like are set in association with one another.

In the sugar intake determination table, desired behavior, a numerical value range of a blood sugar level, a perspiration amount, and alternative behavior are set as items.

Among the items, the alternative behavior is behavior that the user is determined as having no problem in carrying out. More specifically, the alternative behavior is behavior that conforms to the desired behavior and that the user is determined by a behavior determining unit A277 explained below as having no problem in carrying out.

In the sugar intake determination table, for example, in a row in which the blood sugar level is equal to or higher than 140 mg/dl and the perspiration amount is large, behavior “drink sports drink” is set as the alternative behavior. Such content of the sugar intake determination table is created from a medical viewpoint and a nutrition science viewpoint.

In a row in which the blood sugar level is equal to or higher than 140 mg/dl and the perspiration amount is small, behavior “eat a lactic ice cream” is set as the alternative behavior.

Further, in a row in which the blood sugar level is equal to or higher than 120 mg/dl and lower than 140 mg/dl, behavior “eat shaved ice” is set as the alternative behavior irrespective of the perspiration amount.

In addition, in a row in which the blood sugar level is lower than 120 mg/dl, behavior “eat an ice cream” is set as the alternative behavior irrespective of the perspiration amount. That is, when the blood sugar level is lower than 120 mg/dl, since the user does not have hyperglycemia, the input desired behavior is the alternative behavior. In other words, if the blood sugar level is lower than 120 mg/dl, an alternative-behavior determining unit A278 does not function.

That is, when the state of the user is a hyperglycemia symptom, the alternative-behavior determining unit A278 determines, from the sugar intake determination table included in the determination tables, alternative behavior corresponding to the state of the user.

Note that, in the sugar intake determination table, an exercise amount is not provided as an item. However, the item may be provided to determine alternative behavior according to the item. In this case, determination of the exercise amount is performed on the basis of detected body motion information.

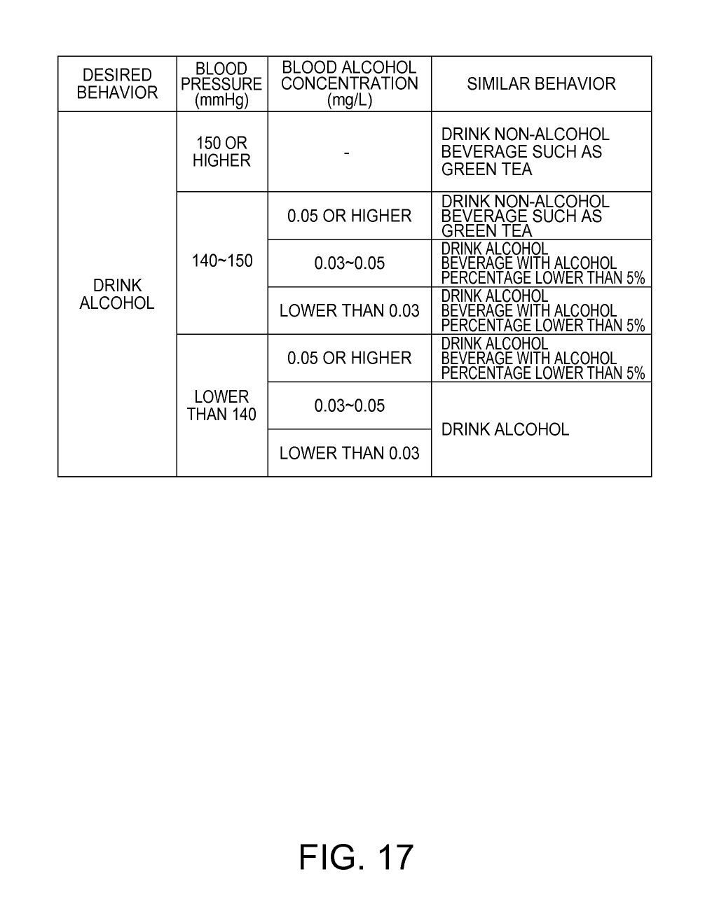

For example, the determination table shown in FIG. 17 is a drinking determination table referred to when the desired behavior is “drink alcohol”. In the drinking determination table, as shown in FIG. 17, states of the user (i.e., a blood pressure and blood alcohol concentration of the user), alternative behavior (e.g., behavior with which the user can enjoy a commodity suitable for the user), and the like are set in association with one another.

In the drinking determination table, desired behavior, a numerical value range of a blood pressure, a numerical value range of blood alcohol concentration, and alternative behavior are set as items.

In the drinking determination table, for example, in a row in which the blood pressure is equal to or higher than 150 mmHg, behavior “drink a non-alcohol beverage such as green tea” is set as the alternative behavior. Such content of the drinking determination table is created from a medical viewpoint and a nutrition science viewpoint.

In a row in which the blood pressure is equal to or higher than 140 mmHg and lower than 150 mmHg and the blood alcohol concentration is 0.05 mg/L, behavior “drink a non-alcohol beverage such as green tea” is set as the alternative behavior. On the other hand, in a row in which the blood pressure is equal to or higher than 140 mmHg and lower than 150 mmHg and the blood alcohol concentration is equal to or higher than 0.03 mg/L and lower than 0.05 mg/L, behavior “drink an alcohol beverage with alcohol percentage lower than 5%” is set as the alternative behavior. Further, in a row in which the blood pressure is equal to or higher than 140 mmHg and lower than 150 mmHg and the blood alcohol concentration is lower than 0.03 mg/L, behavior “drink an alcohol beverage with alcohol percentage lower than 5%” is set as the alternative behavior.

Further, in a row in which the blood pressure is lower than 140 mmHg and the blood alcohol concentration is equal to or higher than 0.05 mg/L, behavior “drink an alcohol beverage with alcohol percentage lower than 5%” is set as the alternative behavior. On the other hand, in rows in which the blood pressure is lower than 140 mmHg and the blood alcohol concentration is equal to or higher than 0.03 mg/L and lower than 0.05 mg/L and is lower than 0.03 mg/L, behavior “drink alcohol (normal drinking is possible)” is set as the alternative behavior.

That is, when the blood pressure is lower than 140 mmHg and the blood alcohol concentration is lower than 0.03 mg/L, since the blood pressure and the blood alcohol concentration are not so high, the input desired behavior is the alternative behavior. In other words, if the blood pressure is lower than 140 mmHg and the blood alcohol concentration is lower than 0.03 mg/L, the alternative-behavior determining unit A278 does not function.

That is, when the blood pressure of the user is relatively high or when the blood alcohol concentration is relatively high, the alternative-behavior determining unit A278 determines, from the drinking determination table included in the determination tables, alternative behavior corresponding to the state of the user.

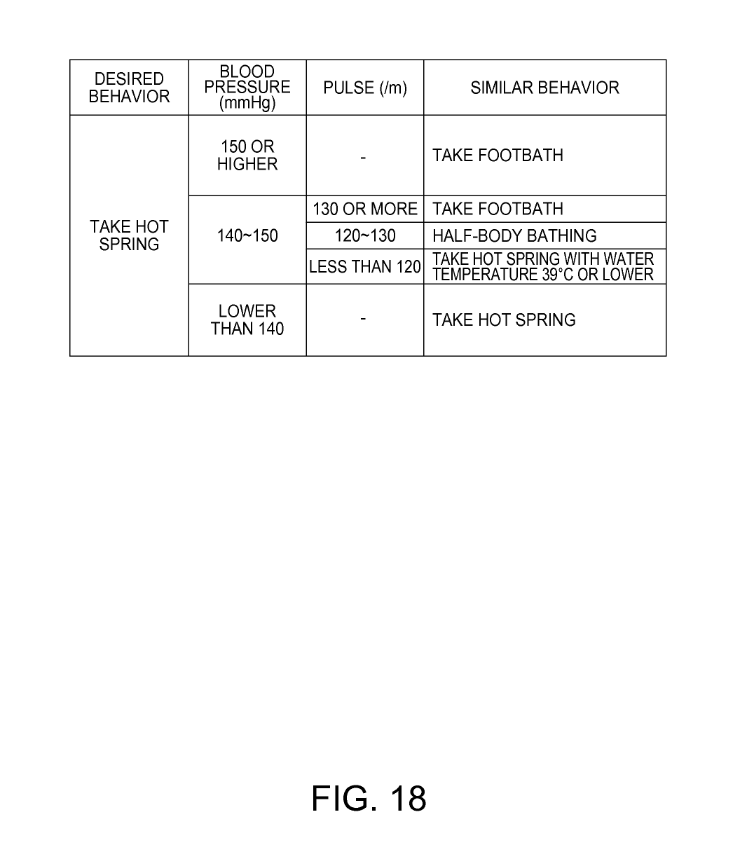

Further, for example, the determination table shown in FIG. 18 is a bathing determination table referred to when the desired behavior is “take a hot spring”. In the bathing determination table, as shown in FIG. 18, states of the user (i.e., a blood pressure and a pulse of the user), alternative behavior (e.g., behavior with which the user can enjoy a service suitable for the user), and the like are set in association with one another.

In the bathing determination table, desired behavior, a numerical value range of a blood pressure, a numerical value range of a pulse, and alternative behavior are set as items.

In the bathing determination table, for example, in a row in which the blood pressure is equal to or higher than 150 mmHg, behavior “taking a footbath” is set as the alternative behavior. Such content of the bathing determination table is created from a medical viewpoint and a nutrition science viewpoint.

In a row in which the blood pressure is equal to or higher than 140 mmHg and lower than 150 mmHg and the pulse is equal to or more than 130/min, behavior “take a footbath” is set as the alternative behavior. On the other hand, in a row in which the blood pressure is equal to or higher than 140 mmHg and lower than 150 mmHg and the pulse is equal to or more than 120/min and less than 130/min, behavior “take half-body bathing” is set as the alternative behavior. Further, in a row in which the blood pressure is equal to or higher than 140 mmHg and lower than 150 mmHg and the pulse is less than 120/min, behavior “take a hot spring with a water temperature equal to or lower than 39° C.” is set as the alternative behavior.

Further, in a row in which the blood pressure is lower than 140 mmHg, behavior “take a hot spring” is set as the alternative behavior. That is, when the blood pressure is lower than 140 mmHg, since the user does not have a high pressure, the input desired behavior is the alternative behavior. In other words, if the blood pressure is lower than 140 mmHg, the alternative-behavior determining unit A278 does not function.

That is, when the state of the user is the high pressure, the alternative-behavior determining unit A278 determines, from the bathing determination table included in the determination tables, alternative behavior corresponding to the state of the user.

The storing unit A26 stores detection information (biological information, body motion information, and position information) detected and acquired by the detecting unit 22 and user information acquired by an information acquiring unit A275 explained below.

For example, as the behavior presentation control program, the storing unit A26 has stored therein a behavior presentation control program for executing behavior presentation processing for determining, on the basis of biological information, body motion information, and user information of the user, whether the user has a problem in carrying out desired behavior that the user desires to carry out and, when it is determined that the user has a problem in carrying out the desired behavior, presenting behavior conforming to the desired behavior, that is, alternative behavior that the user is determined on the basis of the biological information as having no problem in carrying out.

### Configuration of the Control Unit

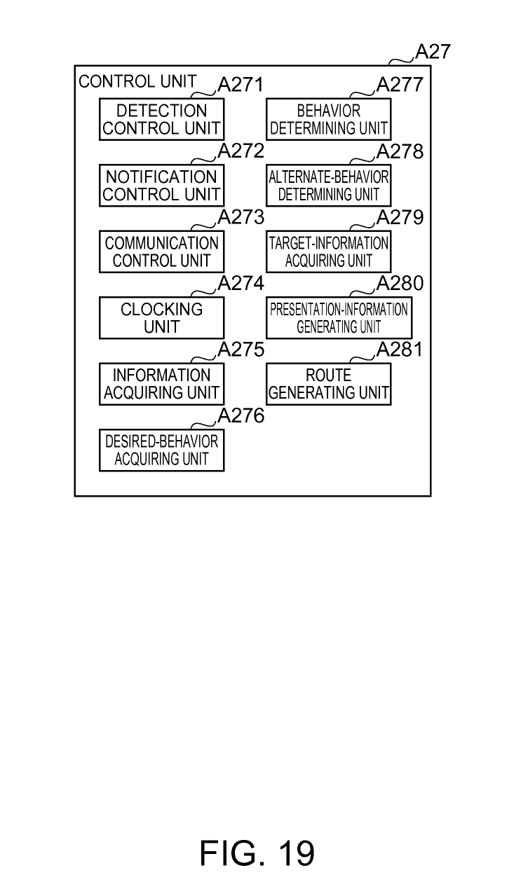

FIG. 19 is a block diagram showing the configuration of the control unit A27.

The control unit A27 is configured by a processing circuit such as a CPU and controls the operation of the behavior supporting apparatus A2 autonomously or on the basis of an operation signal input from the operation unit A21 according to the operation by the user. For example, the control unit A27 analyzes biological information and body motion information detected by the detecting unit A22. Besides, the control unit A27 determines, on the basis of input user information in addition to the biological information and the body motion information, whether the user has a problem in carrying out input desired behavior. When determining that the user has a problem in carrying out the desired behavior, the control unit A27 presents the alternative behavior instead of the desired behavior.

The control unit A27 includes, as functional units realized by the control circuit executing the computer programs stored in the storing unit A26, as shown in FIG. 19, a detection control unit A271, a notification control unit A272, a communication control unit A273, a clocking unit A274, an information acquiring unit A275, a desired-behavior acquiring unit A276, a behavior determining unit A277, an alternative-behavior determining unit A278, a target-information acquiring unit A279, a presentation-information generating unit A280, and a route generating unit A281.

The detection control unit A271 controls the operation of the detecting unit A22 and causes the storing unit A26 to store a detection result by the detecting unit A22. In a state in which the behavior supporting apparatus A2 is worn by the user and detection of biological information and body motion information by the detecting unit A22 is possible, the detection control unit A271 causes the detecting unit A22 to detect the respective kinds of information. In a state in which the detection of the respective kinds of information by the detecting unit A22 cannot be executed, the detection control unit A271 stops the operation of the detecting unit A22. Therefore, when the behavior supporting apparatus A2 is worn by the user, the detected biological information and the detected operation information are stored in the storing unit A26. When the behavior supporting apparatus A2 is not worn by the user, these kinds of information are not stored. Therefore, power consumption can be reduced.

The notification control unit A272 controls the operation of the notifying unit A24. For example, the notification control unit A272 controls the operation of the display unit A241 of the notifying unit A24 and causes the display unit A241 to display the biological information and the body motion information detected by the detecting unit A22.

When the behavior determining unit A277 determines that the biological information of the user is not within the normal ranges, the notification control unit A272 causes the vibrating unit A243 to operate and causes the user to notice the display content. Further, the notification control unit A272 presents, with the notifying unit A24 (specifically, the display unit A241), the user with information including behavior content of alternative behavior generated by the presentation-information generating unit A280 and route information generated by the route generating unit A281.

The notification control unit A272 presents, with the notifying unit A24, the user with the information generated by the presentation-information generating unit A280 and the route generating unit A281. Therefore, the notification control unit A272 and the notifying unit A24 configure the behavior presenting unit according to the invention.

The communication control unit A273 controls the operation of the communication unit A25 and causes the communication unit A25 to communicate with the server 3 on the basis of the connection information stored in the storing unit A26.

The clocking unit A274 clocks the present time. The time clocked by the clocking unit A274 is used for, for example, determination concerning whether the clocked time is included in an opening hour of a facility (a store) that provides a commodity and a service enjoyed by the user.

The information acquiring unit A275 acquires the biological information and the body motion information detected by the detecting unit A22 and the position information acquired by the receiving unit A23 and causes the storing unit A26 to store these kinds of information. The information acquiring unit A275 acquires user information. The user information includes an attribute, presence or absence of a symptom, and taste in a commodity of the user which can be input on the user information input screen. Besides, the user information includes a behavior history of the user.

Examples of the behavior history include “when and where the user went” and “a running route of everyday running”. The behavior history is acquired on the basis of the position information stored in the storing unit A26.

The desired-behavior acquiring unit A276 acquires behavior content of the desired behavior input by the user through the input operation to the operation unit A21. When the desired behavior is input by the user and acquired by the desired-behavior acquiring unit A276, behavior presentation processing is executed. The behavior presentation processing is explained below.

The behavior determining unit A277 functions when the desired-behavior acquiring unit A276 acquires behavior content of desired behavior input by the user. The behavior determining unit A277 determines on the basis of the detected biological information and the detected body motion information and the acquired user information whether the user has a problem in carrying out the desired behavior.

Specifically, the behavior determining unit A277 refers to the determination tables stored in the storing unit A26, compares content of biological information corresponding to the desired behavior and the detected biological information, and determines whether the user has a problem in carrying out the desired behavior.

For example, when behavior content of the desired behavior is “eat an ice cream”, the behavior determining unit A277 refers to a determination table (the sugar intake determination table shown in FIG. 16) corresponding to the desired behavior. The behavior determining unit A277 compares content of biological information stored in the determination table and the present biological information of the user.

For example, if the present blood sugar level of the user is lower than 120 mg/dl, the behavior determining unit A277 determines that the user has no problem in carrying out the acquired desired behavior.

On the other hand, if the present blood sugar level of the user is equal to or higher than 120 mg/dl, the behavior determining unit A277 determines that the user has a problem in carrying out the acquired desired behavior.

The alternative-behavior determining unit A278 functions when the behavior determining unit A277 determines that the user has a problem in carrying out the desired behavior. The alternative-behavior determining unit A278 determines alternative behavior presented to the user by acquiring alternative behavior corresponding to relevant biological information in the determination table referred to by the behavior determining unit A277.

For example, if the behavior content of the desired behavior is “eat an ice cream” and the present blood sugar level of the user is 130 mg/dl, the alternative-behavior determining unit A278 determines “eat shaved ice” as behavior content of the alternative behavior.

When the behavior determining unit A277 determines that the user has no problem in carrying out the desired behavior, the target-information acquiring unit A279 acquires information concerning an enjoyment target (at least one of a service and a commodity) included in the desired behavior.

When the behavior determining unit A277 determines that the user has a problem in carrying out the desired behavior, the target-information acquiring unit A279 acquires information concerning an enjoyment target included in the alternative behavior. Specifically, the target-information acquiring unit A279 sets search conditions based on the enjoyment target, position information indicating the present position of the user, and the user information and transmits the search conditions to the server 3 via the communication unit A25. In the server 3, information corresponding to the search conditions (information concerning the enjoyment target and information concerning a store capable of providing the enjoyment target) is searched. When the information is received by the communication unit A25 from the server 3, the target-information acquiring unit A279 acquires the received information. The target-information acquiring unit A279 is equivalent to the article-information acquiring unit and the place-information acquiring unit according to the invention.

For example, when a detected blood sugar level of the user is equal to or higher than 140 mg/dl and the alternative behavior determined by the alternative-behavior determining unit A278 is “drink a sports drink”, the target-information acquiring unit A279 sets search conditions including the “sports drink”, which is an enjoyment target of the alternative behavior, the user information, and the present position of the user. According to the search condition, the server 3 acquires, from the detailed information table 312, a commodity ID of a commodity (e.g., a commodity having weak sweetness) corresponding to the “sports drink” and corresponding to taste in food of the user included in the user information. The server 3 acquires commodity information such as a commodity name of the commodity ID and a store selling the commodity referring to the content table 311 and acquires, referring to the store information table 313 and the transaction commodity information tables 321, 331, and 341, information concerning a place (a store) that is currently open and close to the present position and in which a stock of the commodity is not 0 among places where the user can enjoy the commodity. These search results are transmitted from the server 3 to the behavior supporting apparatus A2. The target-information acquiring unit A279 acquires the search results.

In this way, the target-information acquiring unit A279 acquires, for example, information concerning the commodity name “ww water” as a candidate of the enjoyment target “sports drink” of the alternative behavior. Besides, the target-information acquiring unit A279 acquires information concerning a store that is currently open and close to the present position of the user and in which a stock of the commodity is not 0 among stores selling the enjoyment target.

The presentation-information generating unit A280 generates, on the basis of the determined alternative behavior and the acquired search result, presentation information indicating proposal content to the user. The presentation information generated by the presentation-information generating unit A280 is notified (displayed) to the notifying unit A24 (on the display unit A241) according to the control by the notification control unit A272.

The presentation information includes information indicating a state of the user (e.g., a hyperglycemia symptom), information indicating alternative behavior (information indicating a commodity suitable for the user), and information indicating a place where the commodity can be acquired.

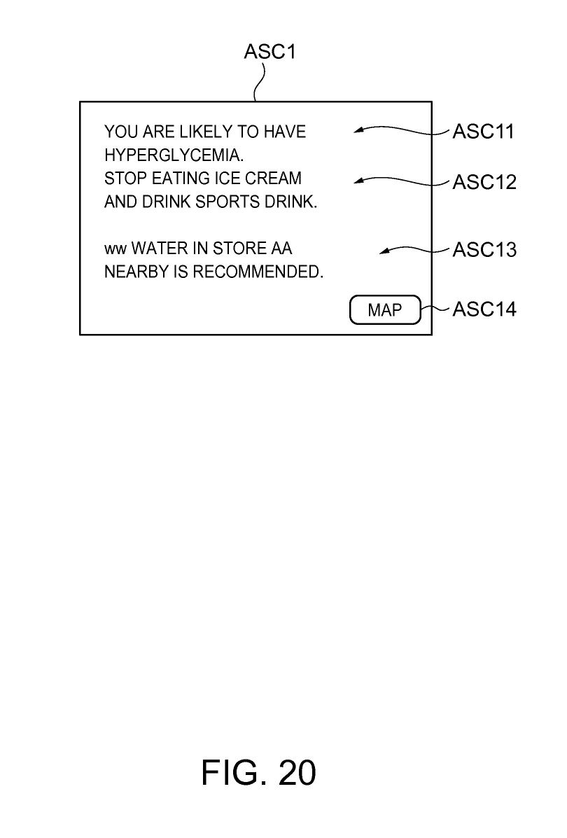

FIG. 20 is a diagram showing an example of an information presentation screen ASC1 generated by the presentation-information generating unit A280.

For example, the information presentation screen ASC1 generated by the presentation-information generating unit A280 when alternative behavior is presented includes, as shown in FIG. 20, a region ASC11 wherein a reason for presenting the alternative behavior (i.e., a reason why it is determined that the user has a problem in carrying out the desired behavior) is set, a region ASC12 where content of the alternative behavior is set, and a region ASC13 where information concerning an enjoyment target of the alternative behavior is set.

In the example shown in FIG. 20, in the region ASC11, content to the effect that “the user is likely to have a hyperglycemia symptom” is set. In the region ASC12, instead of an ice cream, which is an enjoyment target of the desired behavior, an explanatory note for recommending intake of a sports drink, which is the enjoyment target of the alternative behavior, is set. In the region ASC13, an explanatory note for recommending the “ww water”, which is a candidate of the sports drink, is set.

The information presentation screen ASC1 is displayed on the display unit A241 by the notification control unit A272. Consequently, the generated presentation information (the information presentation screen ASC1) is presented to the user.

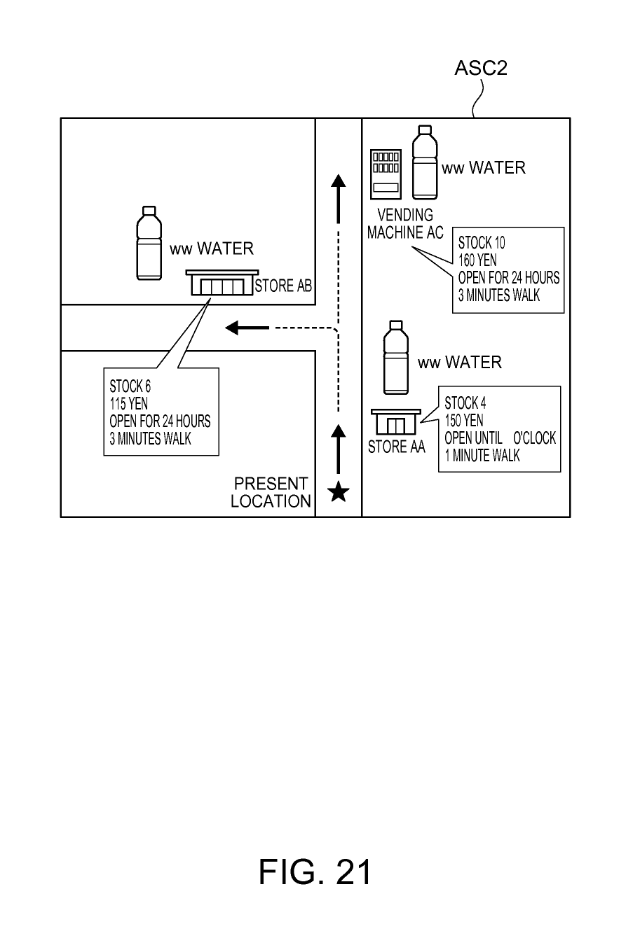

Note that, on the information presentation screen ASC1, a button ASC14 for displaying a route guide screen ASC2 (see FIG. 21) indicating a route to a place where the candidate of the enjoyment target included in the explanatory note set in the region ASC13 can be enjoyed is set. The route guide screen ASC2 is generated by the route generating unit A281.

The route generating unit A281 generates a screen that is included in the search result acquired by the target-information acquiring unit A279 and presents information concerning a place (a store) where the enjoyment target can be enjoyed. Specifically, the route generating unit A281 generates a route guide screen including a route from the present position to the place where the enjoyment target can be enjoyed and information concerning the place.

FIG. 21 is a diagram showing an example of the route guide screen ASC2.

For example, the route generating unit A281 generates the route guide screen ASC2 shown in FIG. 21.

On the route guide screen ASC2, a map around the present position of the user is set. Besides, information concerning an enjoyment target acquired as a search result and information concerning stores selling the enjoyment target (a store AA, a store AB, and a vending machine AC) are set. Specifically, on the route guide screen ASC2, a commodity name and a photograph of the “ww water” are set as the information concerning the enjoyment target. On the route guide screen ASC2, as the information concerning the stores selling the enjoyment target, positions of the stores are displayed on the map. Besides, stocks and prices in the stores, business information of the stores, and required times from the present position to the stores are set.

As explained above, when the button ASC14 of the information presentation screen ASC1 is pressed (input), the route guide screen ASC2 is generated by the route generating unit A281 and displayed on the display unit A241 under the control by the notification control unit A272.

Note that, for example, when entrance of the user into the store AA is determined on the basis of acquired position information, the route generating unit A281 generates, on the basis of an acquired display position of the “ww water” in the store AA, a route from an entrance of the store AA to a display position of the “ww water” and generates a store guide screen including the route. The store guide screen is displayed on the display unit A241 under the control by the notification control unit A272, whereby the user can be guided to the display position.

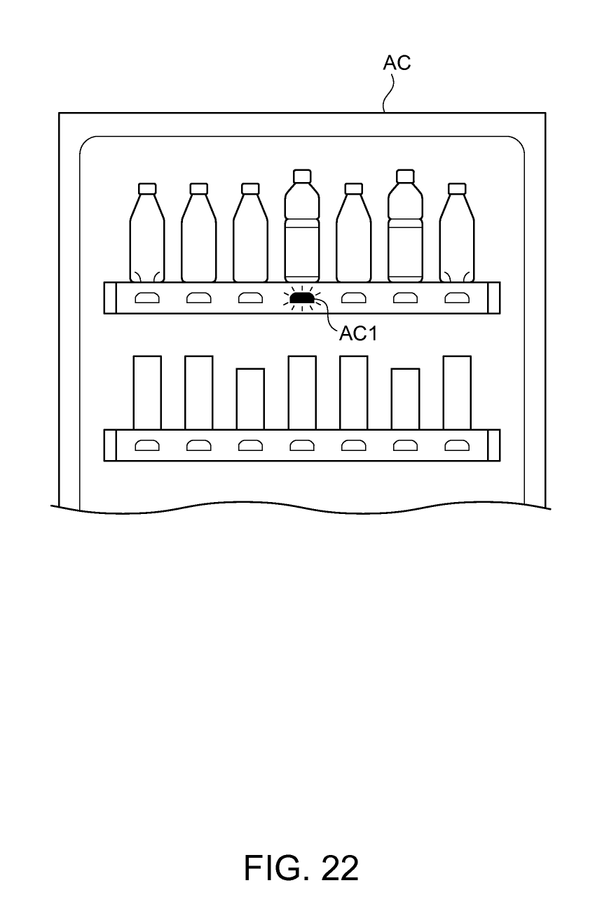

FIG. 22 is a diagram showing an example of a vending machine in which commodity presentation processing is executed.

On the other hand, when the behavior supporting apparatus A2 enters within a communicable range by the vending machine AC, the vending machine AC communicates with the behavior supporting apparatus A2 and acquires information concerning the enjoyment target (e.g., a commodity ID). As shown in FIG. 22, the vending machine AC causes a purchase button AC1 for the article to blink. Consequently, the user can easily identify the target enjoyment target.

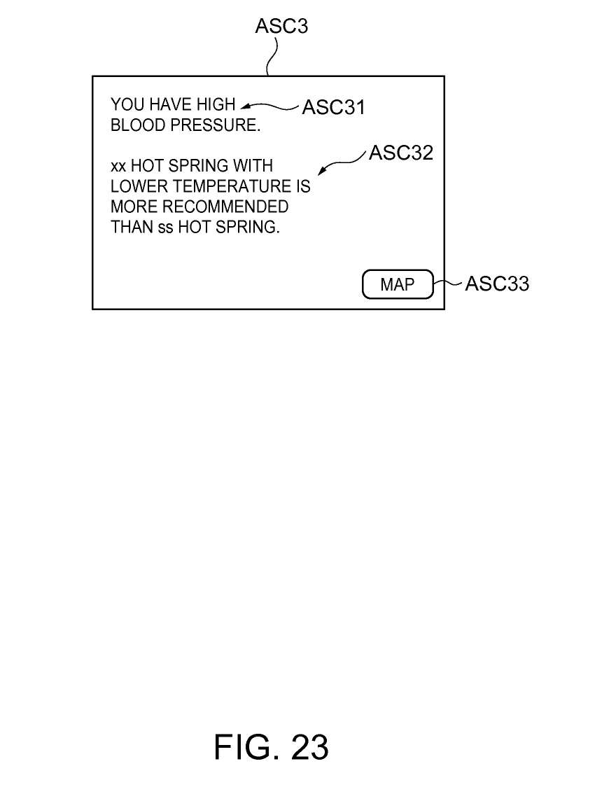

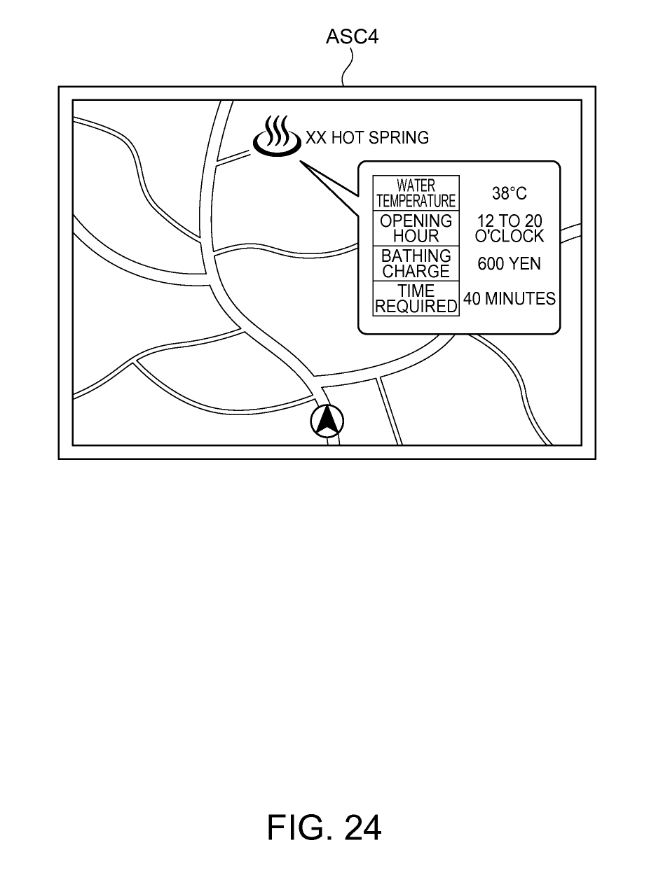

FIG. 23 is a diagram showing an example of an information presentation screen ASC3. FIG. 24 is a diagram showing an example of a route guide screen ASC4.

Another example of the information presentation screen generated by the presentation-information generating unit A280 and the route guide screen generated by the route generating unit A281 is explained.

For example, the information presentation screen ASC3 generated by the presentation-information generating unit A280 when alternative behavior is presented includes, as shown in FIG. 23, a region ASC31 where a reason for presenting the alternative behavior is set and a region ASC32 where information concerning an enjoyment target of the alternative behavior is set.

In the example shown in FIG. 23, in the region ASC31, content to the effect that “the user is likely to have a high pressure” is set. In the region ASC32, an explanatory note for recommending taking an xx hot spring, which is the enjoyment target of the alternative behavior, instead of an ss hot spring, which is the enjoyment target of the desired behavior, is set.

The information presentation screen ASC3 is displayed on the display section A241 by the notification control unit A272. Consequently, the generated presentation information (the information presentation screen ASC3) is presented to the user.

Note that, on the information presentation screen ASC3, a button ASC33 for displaying the route guide screen ASC4 (see FIG. 24) indicating a route to a place where the candidate of the enjoyment target included in the explanatory note set in the region ASC32 can be obtained is set. The route guide screen ASC4 is generated by the route generating unit A281.

For example, the route generating unit A281 generates the route guide screen ASC4 shown in FIG. 24.

On the route guide screen ASC4, a map around the present position of the user is set. Beside, information concerning an enjoyment target acquired as a search result is set. Specifically, on the route guide screen ASC4, a name of the “xx hot spring” is set as the information concerning the enjoyment target. On the route guide screen ASC4, as the information concerning the place, a position of the xx hot spring is displayed on the map. Besides, a water temperature, an opening hour, and a bathing charge in the xx hot spring and a required time from the present position to the xx hot spring are set.

As explained above, when the button ASC33 of the information presentation screen ASC3 is pressed (input), the route guide screen ASC4 is generated by the route generating unit A281 and displayed on the display unit A241 under the control by the notification control unit A272.

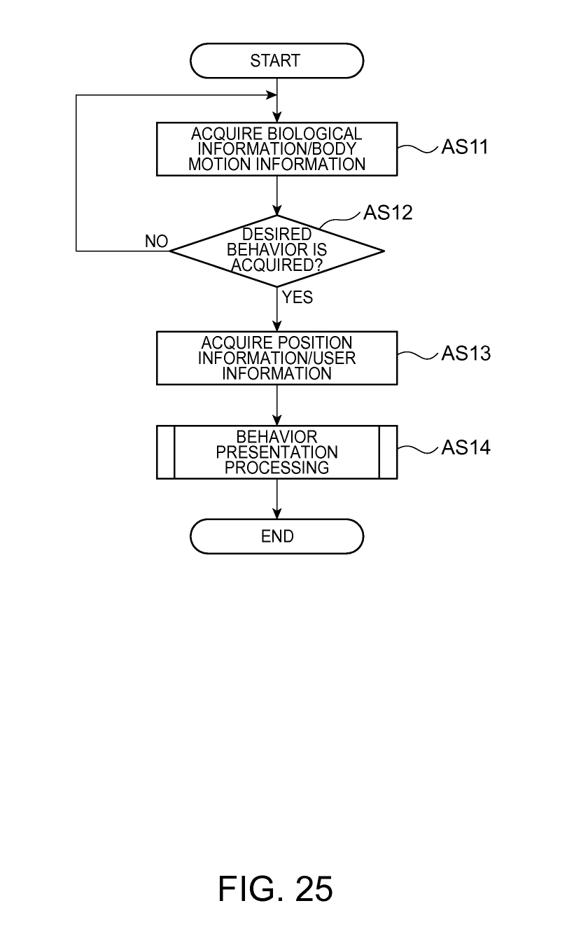

FIG. 25 is a flowchart for explaining presentation control processing.

The control unit A27 executes the presentation control processing explained below on the basis of a computer program stored in the storing unit A26. The presentation control processing determines on the basis of biological information, body motion information, and user information of the user whether the user has a problem in carrying out desired behavior that the user desires to carry out. When it is determined that the user has a problem in carrying out the desired behavior, the presentation control processing presents alternative behavior that is behavior conforming to the desired behavior, that is, alternative behavior that the user is determined on the basis of the biological information as having no problem in carrying out.

Specifically, in the presentation control processing, as shown in FIG. 25, the biological-information detecting unit A221 and the body-motion-information detecting unit A222 of the detecting unit A22 detect biological information and body motion information of the user. The information acquiring unit A275 causes the storing unit A26 to store these kinds of information (step AS11).

Thereafter, the control unit A27 determines whether desired behavior is acquired by the desired-behavior acquiring unit A276 (step AS12).

When it is determined in determination processing in step AS12 that desired behavior is not acquired, the control unit A27 returns the processing to step AS11.

On the other hand, when it is determined in the determination processing in step AS12 that desired behavior is acquired, the information acquiring unit A275 acquires the position information acquired by the receiving unit A23 and the user information stored in the storing unit A26 (step AS13).

The control unit A27 executes behavior presentation processing AS14.

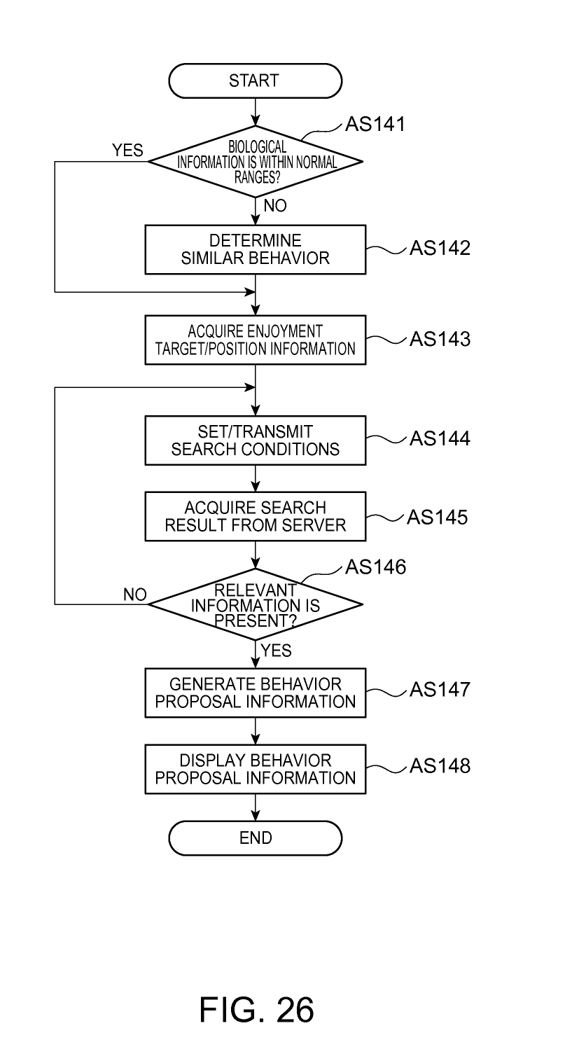

FIG. 26 is a flowchart for explaining the behavior presentation processing.

The control unit A27 executes, on the basis of a computer program stored in the storing unit A26, the behavior presentation processing AS14 explained below. The behavior presentation processing AS14 is processing for presenting behavior suitable for the user and supporting the behavior by the user.

In the behavior presentation processing AS14, as shown in FIG. 26, first, the behavior determining unit A277 determines on the basis of detected biological information and detected body motion information and acquired user information whether the user has a problem in carrying out the desired behavior (step AS141).

When it is determined in determination processing in step AS141 that the user has a problem in carrying out the desired behavior, the alternative-behavior determining unit A278 determines alternative behavior presented to the user by acquiring alternative behavior corresponding to relevant biological information in the determination table referred to by the behavior determining unit A277 (step AS142). On the other hand, when it is determined in the determination processing in step AS141 that the user has no problem in carrying out the desired behavior, the processing shifts to the next processing.

When the behavior determining unit A277 determines that the user has no problem in carrying out the desired behavior, the target-information acquiring unit A279 acquires information concerning an enjoyment target (at least one of a service and an article) included in the desired behavior. When the behavior determining unit A277 determines that the user has no problem in carrying out the desired behavior, the target-information acquiring unit A279 acquires information (target information) concerning the enjoyment target included in the alternative behavior and position information of the user (step AS143).

The target-information acquiring unit A279 sets search conditions based on the enjoyment target, the position information indicating the present position of the user, and the user information and transmits the search conditions to the server 3 via the communication unit A25 (step AS144).

Subsequently, when information corresponding to the search conditions (information of the enjoyment target and information concerning a store capable of providing the enjoyment target) is searched in the server 3 and the information is received by the communication unit A25 from the server 3, the target-information acquiring unit A279 acquires the received information (step AS145).

Thereafter, the target-information acquiring unit A279 determines whether information corresponding to the search conditions (information concerning a store selling the enjoyment target) is present in the search result (step AS146).

When it is determined in determination processing in step AS146 that information corresponding to the search conditions is not included in the acquired search result, the target-information acquiring unit A279 returns to step AS144 and transmits broader search conditions to the server 3.

On the other hand, when it is determined by the determination in step AS146 that information corresponding to the search conditions is included in the search result, the presentation-information generating unit A280 generates, on the basis of the determined alternative behavior and the acquired search result, presentation information indicating proposal content to the user (step AS147).

The notification control unit A272 causes the display unit A241 to display information presentation screen (e.g., the information presentation screen ASC1 or ASC3) including the presentation information generated by the presentation-information generating unit A280 (step AS148).

After processing in step AS148, the behavior presentation processing is ended.

When the “MAP” button on the displayed information presentation screen is pressed, the notification control unit A272 causes the display unit A241 to display the route guide screen (e.g., the route guide screen ASC2 or ASC4) generated by the route generating unit A281.

### Effects of the Fourth Embodiment

With the behavior supporting system according to this embodiment explained above, there are effects explained below.

The behavior determining unit A277 determines on the basis of biological information whether the user has a problem in carrying out desired behavior that the user desires to carry out. When it is determined that the user has a problem in carrying out the desired behavior, alternative behavior that the user has no problem in carrying out is proposed on the basis of the biological information. The alternative behavior is presented.

Consequently, it is possible to prevent the desired behavior carried out by the user with a problem from being carried out. It is possible to urge the user to carry out the alternative behavior, which is an alternative of the desired behavior. Therefore, the user can execute behavior suitable for a state of the user by executing the presented alternative behavior.

The alternative behavior is behavior that the user is determined as having no problem in carrying out and that conforms to the desired behavior. Consequently, the alternative behavior conforming to the desired behavior of the user is presented. Therefore, it is possible to make it easy to urge the user to perform the alternative behavior. Besides, it is possible to suppress resistance of the user in carrying out the alternative behavior. Therefore, it is possible to make it easy to cause the user to execute behavior suitable for a state of the user.

When the user has a problem in carrying out the desired behavior, it is possible to propose the alternative behavior in which the enjoyment target is changed. That is, when the user has a problem in carrying out the desired behavior, it is possible to propose alternative behavior conforming to the desired behavior by changing the enjoyment target. Therefore, it is possible to easily propose and present the alternative behavior.

Article information concerning an article included in the enjoyment target of the alternative behavior is acquired from the server 3. The article information is presented. Consequently, it is possible to present the user with article information matching a state of the user and concerning the article included in the enjoyment target of the alternative behavior changed from the enjoyment target of the desired behavior. Therefore, it is possible to present the user with detailed information concerning the article. The behavior supporting apparatus A2 does not need to retain article information concerning respective articles that are likely to be presented. Therefore, it is possible to reduce a storage capacity of the storing unit A26 of the behavior supporting apparatus A2.

Place information concerning a place where the enjoyment target of the alternative behavior can be enjoyed is acquired from the server 3. The acquired place information is presented to the user. Consequently, it is possible to cause the user to recognize a place where the user can enjoy the enjoyment target of the alternative behavior. Since the place information presented in this way is place information acquired on the basis of the present position of the user, for example, it is possible to present the user with a providing place relatively close to the present position. Therefore, the user can easily carry out the alternative behavior.

At least one of the route generated by the route generating unit A281 and the required time in moving from the present position to the place where the enjoyment target can be enjoyed is presented. Therefore, the user can more easily carry out the presented alternative behavior.

When the biological-information detecting unit A221 detects a blood pressure as the biological information and the desired behavior of the user is “take a hot spring”, if the user is in a high blood pressure state, it is conceivable to present, as alternative behavior, bathing in a hot spring with relatively low water temperature. However, depending on a medical history of the user, for example, full-body bathing is sometimes undesirable even if water temperature is low.

On the other hand, when the alternative behavior conforming to the desired behavior of the user is presented, the alternative behavior based on the user information besides the biological information is presented. Consequently, for example, it is possible to present a user for whom the full-body bathing is undesirable with alternative behavior of taking a hot spring in half-body bathing or alternative behavior of taking a footbath. Therefore, it is possible to present behavior more suitable for a state of the user.

When the biological-information detecting unit A221 detects a blood sugar level as the biological information and the desired behavior of the user is “eat an ice cream”, if the detected blood sugar level of the user is a value classified into hyperglycemia, it is possible to present alternative behavior of “drink sports drink containing less sugar than the ice cream” instead of the desired behavior. Therefore, even when the user does not notice abnormality of the body, it is possible to present alternative behavior suitable for the body. It is possible to urge the user to perform behavior for changing a state of the user to a satisfactory state.

The behavior determining unit A277 determines on the basis of not only the biological information detected by the biological-information detecting unit A221 but also the body motion information detected by the body-motion-information detecting unit A222 whether the user has a problem in carrying out the desired behavior. Consequently, it is possible to more appropriately detect and grasp a state of the user. Therefore, it is possible to more appropriately determine whether the user has a problem in carrying out the desired behavior and whether alternative behavior needs to be proposed and presented.

The alternative-behavior determining unit A278 determines alternative behavior conforming to the desired behavior on the basis of the plurality of determination tables stored in the storing unit A26. Consequently, it is possible to accurately and easily determine presented behavior presented on the display unit A241 according to the control by the notification control unit A272. Therefore, it is possible to simplify processing concerning proposal and determination of the alternative behavior. Besides, it is possible to surely present alternative behavior suitable for the user.

By detecting a pulse wave, a heartbeat, a blood pressure, a blood sugar level, a perspiration amount, and blood alcohol concentration of the user as the biological information, the biological-information detecting unit A221 can perform in detail and appropriately, on the basis of the biological information, the determination by the behavior determining unit A277 concerning whether the user has a problem in carrying out the desired behavior.

### Fifth Embodiment

A fifth embodiment of the invention is explained.

A behavior supporting system according to this embodiment includes a configuration same as the behavior supporting system explained above. The behavior supporting system according to this embodiment is different from the behavior supporting system explained above in that a server includes an operation unit and a communication unit and the server includes a part of a function of the control unit that executes behavior presentation processing.

Note that, in the following explanation, components the same as or substantially the same as the components explained above are denoted by the same reference numerals and signs and explanation of the components is omitted.

### Configuration of a Behavior Supporting Apparatus

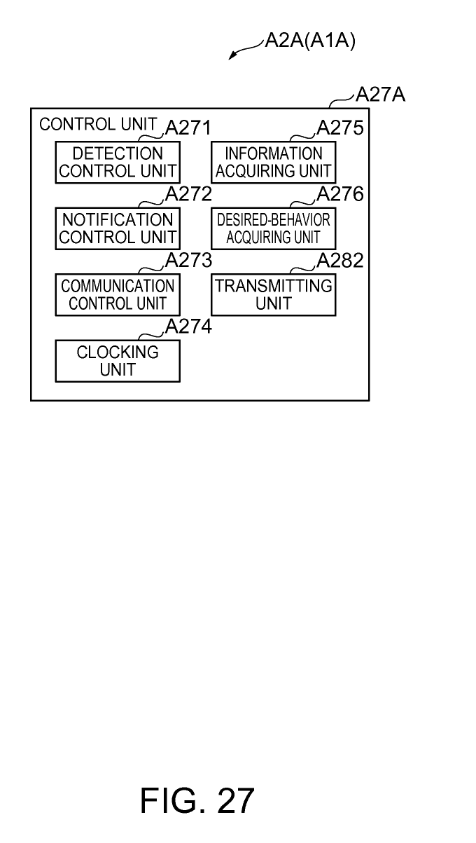

FIG. 27 is a block diagram showing the configuration of a control unit of a behavior supporting apparatus A2A configuring a behavior supporting system A1A according to this embodiment.

Like the behavior supporting system 1, the behavior supporting system A1A according to this embodiment includes the behavior supporting apparatus A2A and a server A3A capable of communicating with the behavior supporting apparatus A2A via the network N.

Among these components, the behavior supporting apparatus A2A is equivalent to the detecting apparatus according to the invention. The configuration of a control unit A27A of the behavior supporting apparatus A2A is partially different from the configuration of the control unit A27 of the behavior supporting apparatus A2.

Specifically, as shown in FIG. 27, the control unit A27A includes the detection control unit A271, the notification control unit A272, the communication control unit A273, the clocking unit A274, the information acquiring unit A275, the desired-behavior acquiring unit A276, and a transmitting unit A282. The units A271 to A276 include configurations same as the configurations of the units A271 to A276 of the control unit A27.

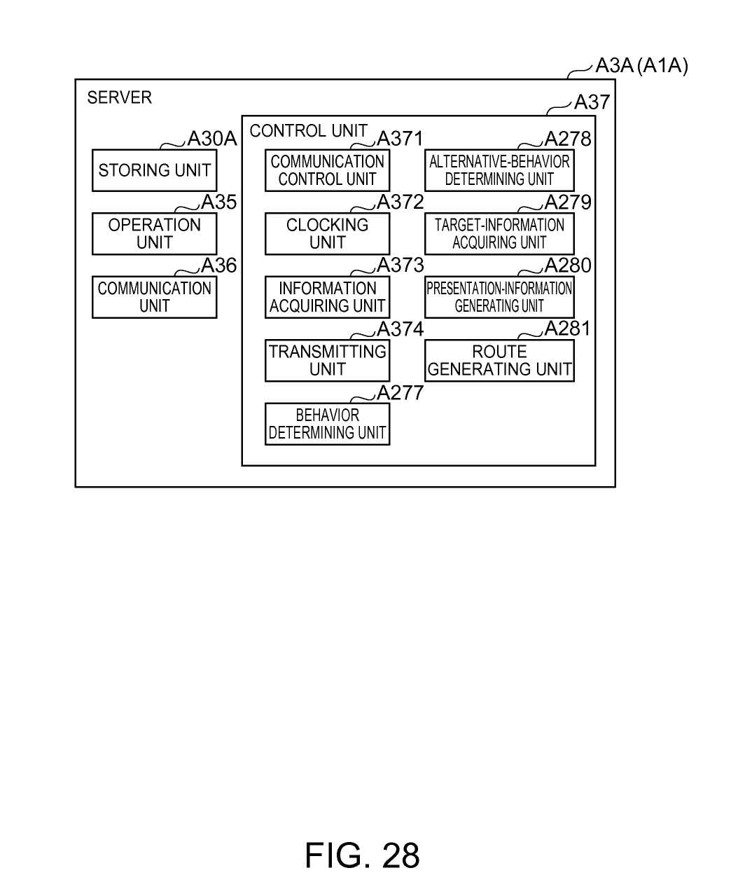

The transmitting unit A282 is equivalent to the detecting-apparatus-side transmitting unit according to the invention. The transmitting unit A282 transmits biological information, body motion information, user information, and information concerning desired behavior of a user acquired by the information acquiring unit A275 and the desired-behavior acquiring unit A276 to the server A3A (see FIG. 28).

### Configuration of the Server

FIG. 28 is a block diagram showing the configuration of the server A3A configuring the behavior supporting system A1A according to this embodiment.

The server A3A is equivalent to the information processing apparatus according to the invention. As shown in FIG. 28, the server A3A includes a storing unit A30A instead of the storing unit 30. Besides, the server A3A includes an operation unit A35, a communication unit A36, and a control unit A37.

Like the storing unit 30, the storing unit A30A has stored therein a database A31, a database A32, a database A33, and a database A34. The storing unit A30A stores the biological information, the body motion information, the user information, and the information concerning desired behavior transmitted from the behavior supporting apparatus A2A. Besides, the storing unit A30A has stored therein in advance the behavior presentation control program stored in the storing unit A26.

The operation unit A35 is configured by a keyboard, a pointing device, a touch panel, and the like and outputs an operation signal corresponding to input operation by the user to the control unit A37.

The communication unit A36 is equivalent to the processing-apparatus-side transmitting unit according to the invention. The communication unit A36 includes a module capable of communicating with the behavior supporting apparatus A2A and transmits and receives information to and from the behavior supporting apparatus A2A under the control by the control unit A37. For example, the communication unit A36 receives biological information, body motion information, and user information from the behavior supporting apparatus A2A and causes the storing unit A30A to store the information. Besides, when information concerning desired behavior is received from the behavior supporting apparatus A2A, the communication unit A36 outputs the information concerning desired behavior to the control unit A37. Further, the communication unit A36 transmits behavior proposal information input from the control unit A37 to the behavior supporting apparatus A2A.

The control unit A37 includes a processing circuit such as a CPU and controls the operation of the server A3A autonomously or according to an operation signal input from the operation unit A35. For example, the control unit A37 executes presentation control processing explained below and transmits presentation information generated by the presentation-information generating unit A280 to the behavior supporting apparatus A2A.

The control unit A37 includes, as functional units realized by the processing circuit executing computer programs stored in the storing unit A30A, as shown in FIG. 28, a communication control unit A371, a clocking unit A372, an information acquiring unit A373, a transmitting unit A374, the behavior determining unit A277, the alternative-behavior determining unit A278, the target-information acquiring unit A279, the presentation-information generating unit A280, and the route generating unit A281.

The communication control unit A371 controls the operation of the communication unit A36.

The clocking unit A372 clocks the present date and time.

The information acquiring unit A373 functions during the execution of the behavior presentation processing by the behavior supporting apparatus A2A and acquires detection information stored in the storing unit A30A.

The transmitting unit A374 is equivalent to the processing-apparatus-side transmitting unit according to the invention. The transmitting unit A374 transmits, to the behavior supporting apparatus A2A, the presentation information generated by the presentation-information generating unit A280 in the behavior presentation processing executed when the information concerning desired behavior is acquired.

Note that the behavior determining unit A277, the alternative-behavior determining unit A278, the target-information acquiring unit A279, the presentation-information generating unit A280, and the route generating unit A281 function as explained above.

### Behavior Presentation Processing

The behavior supporting system A1A according to this embodiment executes the behavior presentation processing according to flowcharts of FIGS. 25 and 26.

First, the behavior supporting apparatus A2A executes processing same as steps AS11 and AS12 shown in FIG. 25. In step AS12, it is determined whether desired behavior is acquired by the desired-behavior acquiring unit A276. When it is determined that the desired behavior is acquired, processing same as step AS13 is executed. Consequently, the information acquiring unit A275 acquires position information and user information of the user.

After step AS13, the transmitting unit A282 transmits biological information, body motion information, position information, user information, and information concerning desired behavior of the user to the server A3A. Consequently, the control unit A37 of the server A3A executes the behavior presentation processing AS14.

In the server A3A, as shown in FIG. 26, the control unit A37 executes the behavior presentation processing AS14 on the basis of a computer program stored in the storing unit A30A.

In the behavior presentation processing AS14, the control unit A37 executes the processing in steps AS141 to AS147. That is, in this embodiment, the processing in steps AS141 to AS147 is executed in the server A3A.

In step AS148, the transmitting unit A374 of the control unit A37 transmits the presentation information generated by the presentation-information generating unit A280 and the route information generated by the route generating unit A281 to the behavior supporting apparatus A2A. The information acquiring unit A275 of the behavior supporting apparatus A2A receives (acquires) the transmitted presentation information and the transmitted route information. The notification control unit A272 causes the display unit A241 to display the information presentation screen including the received presentation information.

According to step AS148, the behavior presentation processing AS14 is ended and the presentation control processing is ended.

Note that, when the “MAP” button disposed on the displayed information presentation screen is pressed, the behavior supporting apparatus A2A transmits information to the effect that the button is pressed to the server A3A. The server A3A receives the information and transmits the route guide screen generated by the route generating unit A281 to the behavior supporting apparatus A2A. In the behavior supporting apparatus A2A that receives the route guide screen, the notification control unit A272 causes the display unit A241 to display the route guide screen.

### Effects of the Fifth Embodiment

With the behavior supporting system A1A according to this embodiment explained above, it is possible to attain effects same as the effects of the behavior supporting system according to the fourth embodiment. Besides, it is possible to attain effects explained below.

In this embodiment, the server A3A performs the determination processing and the behavior presentation processing by the behavior determining unit A277. Therefore, the server A3A executes the processing that consumes relatively large electric power and has a large processing load. Consequently, it is possible to cause the behavior supporting apparatus A2A to operate for a relatively long time. Besides, it is possible to attain a reduction in costs.

### Modifications of the Embodiments

The invention is not limited to the embodiments. Modifications, improvements, and the like in a range in which the object of the invention can be attained are included in the invention.

In the first to third embodiments, the proposal-information generating unit 281 generates, on the basis of a desire of the user, behavior proposal information with which the user can enjoy an article corresponding to the desire of the user. The notification control unit 272 presents the behavior proposal information. However, the invention is not limited to this. The proposal-information generating unit 281 may propose behavior with which the user can enjoy a service corresponding to the desire of the user as explained above. For example, when a blood sugar level of the user is not within the normal range, the proposal-information generating unit 281 may detect a tearoom and propose the user to go to the tearoom and drink juice. Further, when a blood flow of the user is detected as biological information and it is determined that the blood flow is not good, that is, the blood flow is not within a normal range, the treatment-method determining unit 279 may determine a visit to a massage parlor as a treatment method and present a finger pressure therapy in the massage parlor.

In the first to third embodiments, when the abnormality determining unit 277 determines that the biological information of the user is not within the normal range, a potential desire of the user is estimated by the desire estimating unit 278. However, the invention is not limited to this. For example, the abnormality determining unit 277 does not have to be provided. The desire estimating unit 278 may estimate a potential desire of the user at every predetermined time.

In the first and second embodiments, the treatment-method determining unit 279 estimates a potential desire of the user on the basis of the treatment method tables (the hypoglycemia treatment table and the heat stroke treatment table). However, the invention is not limited to this. For example, in the first and second embodiments, as in the third embodiment, the treatment-method determining unit 279 may determine a treatment method without referring to the treatment method tables. Conversely, the storing unit 26 of the behavior supporting apparatus 2 explained in the third embodiment may include the treatment method tables.

In the first and second embodiments, the detecting unit 22 includes the body-motion-information detecting unit 222. The treatment-method determining unit 279 estimates a potential desire of the user on the basis of biological information and body motion information. However, the invention is not limited to this. For example, the body-motion-information detecting unit 222 does not have to be provided. In this case, the desire estimating unit 278 only has to estimate a potential desire of the user on the basis of the biological information. When the desire estimating unit 278 estimates a desire of the user, the biological information referred to is not limited to the content explained in the embodiments. A part of the biological information does not have to be referred to. Other biological information may be referred to instead of at least a part of the biological information or in addition to the biological information. For example, when a sleep desire of the user is determined, a stress index (a value of LF/HF) may be referred to instead of at least a part of the biological information or in addition to the biological information.

In the third embodiment, the heartbeat and the state of the pupils are detected as the biological information and a potential desire of the user is estimated on the basis of the biological information. However, the invention is not limited to this. For example, as in the first and second embodiments, the detecting unit 22 may include the body-motion-information detecting unit 222 and estimate a desire of the user on the basis of the biological information and the body motion information.

In the first to fourth embodiments, the search-result acquiring unit 280 acquires the search result from the server 3 that manages information concerning the supermarket 4, the convenience store 5, and the vending machine 6. However, the invention is not limited to this. For example, if servers that respectively manage information concerning the supermarket 4, the convenience store 5, and the vending machine 6 are provided, the search-result acquiring unit 280 only has to transmit search conditions to the respective servers and acquire search results from the respective servers.

In the first to third embodiments, the search-result acquiring unit 280 acquires a search result of place information of a place where commodity information of a commodity (a supply) corresponding to a potential desire of the user and the commodity can be acquired as search conditions. However, the invention is not limited to this. For example, only the commodity information may be set as the search conditions to acquire the search result or only the place information may be set as the search conditions to acquire the search result.

In the first to third embodiments, the control unit includes the route generating unit 282. However, the invention is not limited to this. For example, the route generating unit 282 does not have to be provided. In this case, the proposal-information generating unit 281 may generate, as behavior proposal information, a position (an address) of a place where the user can acquire a commodity that the user should acquire. The notification control unit 272 may display the behavior proposal information on the display unit 241. Further, the notification control unit 272 may display only the commodity information on the display unit 241 without displaying the place information.

In the first to third embodiments, the notification control unit 272 displays the behavior proposal information on the display unit 241. Further, in the third embodiment, the notification control unit 272 displays the behavior proposal information on the display unit of the not-shown navigation apparatus. However, the invention is not limited to this. For example, the notification control unit 272 may output sound for proposing behavior from the sound output unit 242 or may output the sound while displaying the behavior proposal information on the display units. A light emitting unit may be provided. The light emitting unit may emit light when the behavior proposal information is displayed. Further, the behavior proposal information may be displayed on an information processing apparatus (a PC (Personal Computer), a smart phone, etc.) that communicates with the behavior supporting apparatus 2.

In the first to third embodiments, when the user is located in front of the vending machine C, the purchase button C1 of the vending machine C blinks. However, the invention is not limited to this. For example, the purchase button C1 may be controlled to a lighting state by a not-shown control unit of the vending machine C or may be controlled to a state in which all other commodities are sold out. That is, a commodity that the user should acquire only has to be distinguishable from the other commodities.

In the first and second embodiments, the stores (the store A, the store B, and the vending machine C) are displayed on the route guide screen SC2. However, the invention is not limited to this. For example, according to a state of the user, only the store (e.g., the store A) closest from the position of the user may be displayed or only a store having the largest stock may be displayed. The stores (the store B and the vending machine C) other than the store A may be displayed in a semitransparent state. Further, the store A may be displayed to be highlighted (e.g., vibrate or blink).

In the first and second embodiments, when the user is located in the store A, the route generating unit 282 generates a route to the position of the shelf on which the “ww water” is arrayed in the store A. The notification control unit 272 displays a map of the store A and the set route on the display unit 241 to thereby guide the user to the position of the shelf. However, the invention is not limited to this. For example, a message such as “Welcome. The ww water is on the third shelf on the right side as you faces” may be displayed on a display unit of the terminal apparatus PT1 set in the store A. Further, the message may be displayed on the display unit 241.

In the embodiments, when the warning is output, the warning sound is output from the sound output unit 242 to vibrate the vibrating unit 243. However, the invention is not limited to this. For example, the warning sound may be only output from the sound output unit 242 or the vibrating unit 243 may be only vibrated. Sound output from the sound output unit 242 is not limited to the warning sound. A warning sentence displayed on the display unit 241 may be output as sound.

In the first to third embodiments, the search-result acquiring unit 280 sets the search conditions on the basis of the treatment method determined by the treatment-method determining unit 279 and the user information acquired by the user-information acquiring unit 276. However, the invention is not limited to this. For example, the search conditions may be set on the basis of only the treatment method determined by the treatment-method determining unit 279.

In the first and second embodiments, the behavior supporting apparatus 2 is the wearable apparatus worn by the user. However, the invention is not limited to this. For example, the behavior supporting apparatus 2 may be configured by a detecting apparatus that detects the biological information and the body motion information and an information processing apparatus (a smart phone, etc.) that analyzes the information detected by the detecting apparatus and proposes and notifies behavior.

In the first embodiment, the abnormality determining unit 277 determines whether a blood sugar level of the user is lower than 70 mg/dl and, when the blood sugar level is lower than 70 mg/dl, determines that the user has a hypoglycemia symptom. However, the invention is not limited to this. For example, the abnormality determining unit 277 may determine whether the user has the hypoglycemia symptom on the basis of not only a numerical value of the blood sugar level but also whether the user has performed vigorous exercise immediately before the blood sugar level falls below 70 mg/dl and a behavior history (e.g., the user has diabetes) acquired by the user-information acquiring unit 276. A value of the blood sugar level for determining hypoglycemia is not limited to 70 mg/dl. That is, numerical values set in the treatment method tables can be changed as appropriate.

In the first embodiment, the treatment-method determining unit 279 sets the primary supply and the secondary supply as the search conditions. However, the invention is not limited to this. For example, the treatment-method determining unit 279 may set only the primary supply as the search conditions. In this case, for example, the control unit 27 may determine whether the user acquires the primary supply and, when determining that the user acquires the primary supply, reset the secondary supply as the search conditions, and execute the behavior presentation processing. After the user acquires (takes) the primary supply, the determination by the abnormality-determining unit 277 may be executed.

In the first embodiment, when the user has a hypoglycemia symptom, the treatment-method determining unit 279 determines, as the treatment method for the hypoglycemia symptom, acquisition of a beverage (juice) containing a large amount of glucose. However, the invention is not limited to this. For example, the treatment-method determining unit 279 may determine acquisition of tablets of glucose as the treatment method for the hypoglycemia symptom.

In the second embodiment, unlike the hypoglycemia treatment table in the first embodiment, the primary supply and the secondary supply are not provided. However, the invention is not limited to this. For example, the primary supply may be “sports drink, water” and the secondary supply may be “cooling sheet” or the like. Consequently, the user is more likely to be capable of acquiring, after acquiring the “sports drink” as the primary supply, the “cooling sheet” as the secondary supply. Therefore, by pasting the cooling sheet to, for example, the forehead of the user, the user can be more quickly relieved of a heat stroke and a feverish state.

In the third embodiment, the notification control unit 272 causes the display unit of the not-shown navigation apparatus to present the behavior proposal information. However, the invention is not limited to this. For example, the behavior proposal information may be presented on the display unit 241 of the main body unit of the behavior supporting apparatus or the behavior proposal information may be displayed in a virtual image display region of the HMD. That is, the behavior proposal information may be displayed anywhere as long as the user can recognize the behavior proposal information.

In the first to third embodiments, the behavior supporting system 1 is configured by the behavior supporting apparatus 2 and the server 3 configuring the POS system. The behavior supporting apparatus 2 includes the notification control unit 272, the abnormality determining unit 277, the desire estimating unit 278, the treatment-method determining unit 279, the search-result acquiring unit 280, the proposal-information generating unit 281, and the route generating unit 282. However, the invention is not limited to this. For example, if the detecting apparatus includes only the biological-information detecting unit 221, the detecting-apparatus-side transmitting unit, and the notifying unit 24 and the server includes the units 272 and 276 to 282 and the server-side transmitting unit, it is possible to simplify the configuration of the control unit of the detecting apparatus. Therefore, it is possible to attain a reduction in the costs, a reduction in the weight, and a reduction in the size of the detecting apparatus.

In the first to third embodiments, the operation unit 21 is configured by the physical keys, the touch panel, and the like provided on the housing of the behavior supporting apparatus 2. However, the invention is not limited to this. For example, the detecting apparatus may detect tap operation of the user as input operation. In this case, whether the tap operation is performed only has to be determined on the basis of an acceleration value detected by the body-motion-information detecting unit 222. Alternatively, a detecting unit capable of detecting the tap operation may be separately provided.

In the fourth and fifth embodiments, the desired behavior is the behavior with which the user can enjoy the enjoyment target including at least one of a service and an article. However, the invention is not limited to this. When the enjoyment target is not specified, for example, the desired behavior of the user is “eat something” or “drink something”, the alternative-behavior determining unit A278 may select a commodity suitable for the user as the enjoyment target on the basis of the biological information, the body motion information, the user information, and the like acquired by the information acquiring unit A275. For example, a determination table for the desired behavior of the user in which the enjoyment target is not specified may be separately provided.

The desired behavior of the user is not limited to the contents explained in the embodiments and may be other contents. That is, in desired behavior in which an article is an enjoyment target, the article is not limited to an ice cream and alcohol and may be other articles. In a desired behavior in which a service is an enjoyment target, the service is not limited to a hot spring and may be other services such as massage.

In the fourth and fifth embodiments, the alternative behavior is the behavior that confirms to the desired behavior and that the user has no problem in carrying out. However, the invention is not limited to this. That is, the alternative behavior only has to be behavior that serves as an alternative of the desired behavior and that the user has no problem in carrying out. The alternative behavior does not always need to conform to the desired behavior of the user.

In the fourth and fifth embodiments, the target-information acquiring unit A279 acquires, as the information concerning the enjoyment target included in the desired behavior or the alternative behavior, the information concerning the enjoyment target or the information concerning the store capable of providing the enjoyment target. However, the invention is not limited to this. For example, the target-information acquiring unit A279 may acquire only the information concerning the enjoyment target or may acquire only the information concerning the store capable of providing the enjoyment target.

In the fourth and fifth embodiments, the route generating unit A281 is provided. However, the invention is not limited to this. For example, the route generating unit A281 does not have to be provided. In this case, for example, presentation information generated by the presentation-information generating unit A280 only has to be displayed on the display unit A241.

In the fourth and fifth embodiments, the behavior determining unit A277 determines, on the basis of whether the biological information of the user is within the normal range, whether the user has a problem in carrying out the desired behavior. However, the invention is not limited to this. For example, the behavior determining unit A277 may determine on the basis of an index other than the biological information whether the user has a problem in carrying out the desired behavior.

In the fourth and fifth embodiments, the detecting unit A22 includes the body-motion-information detecting unit A222. The alternative-behavior determining unit A278 determines the alternative behavior on the basis of the biological information, the body motion information, and the user information. However, the invention is not limited to this. For example, the body-motion-information detecting unit A222 does not have to be provided. In this case, the alternative-behavior determining unit A278 only has to determine the alternative behavior on the basis of the biological information and the user information.

In the fourth and fifth embodiments, the information acquiring unit A275 acquires the user information. However, the invention is not limited to this. For example, the information acquiring unit A275 does not have to acquire the user information. In this case, the alternative-behavior determining unit A278 only has to determine the alternative behavior on the basis of the biological information and the body motion information. As explained above, the body-motion-information detecting unit A222 does not have to be provided. The alternative behavior may be determined on the basis of only the biological information.

Further, the biological information used in determining whether the user has no problem in carrying out the desired behavior is not limited to the contents explained in the embodiments. Apart of the biological information does not have to be referred to. Other biological information may be referred to instead of at least a part of the biological information or in addition to the biological information.

In the fourth embodiment, the target-information acquiring unit A279 acquires the search result from the server 3 that stores the information concerning the supermarket 4, the convenience store 5, and the vending machine 6. However, the invention is not limited to this. For example, if servers that respectively manage information concerning the supermarket 4, the convenience store 5, and the vending machine 6 are provided, the target-information acquiring unit A279 only has to transmit search conditions to the respective servers and acquire search results from the respective servers.

In the fifth embodiment, the server A3A is explained as having a part of the functions of the behavior supporting apparatus A2 besides the functions of the server 3. However, the invention is not limited to this. That is, when the server A3A acquires place information concerning a place where the user can enjoy an article and a service of an enjoyment target, the server A3A may communicate with the server 3 and acquire the place information from the server 3. That is, the server 3 and the server A3A may be located on the network N independently from each other.

In the fourth and fifth embodiments, the target-information acquiring unit A279 acquires, as the search conditions, the search result of the place information of the place where the user can acquire commodity information of a commodity suitable for the user and the commodity. However, the invention is not limited to this. For example, only the commodity information may be set as the search condition to acquire the search result or only the place information may be set as the search condition to acquire the search result.

The target-information acquiring unit A279 sets the search conditions on the basis of the enjoyment target, the position information indicating the present position of the user, and the user information. However, the invention is not limited to this. For example, the search conditions may be set on the basis of only the enjoyment target.

In the fourth and fifth embodiments, the control unit A27 includes the route generating unit A281. However, the invention is not limited to this. For example, the route generating unit A281 does not have to be provided. In this case, the presentation-information generating unit A280 may generate, as presentation information, a position (an address) of a place where the user can acquire a commodity that the user should acquire. The notification control unit A272 may cause the display unit A241 to display the presentation information. Further, the notification control unit A272 may display only the commodity information on the display unit A241 without displaying the place information.

In the fourth and fifth embodiments, the notification control unit A272 displays the presentation information on the display unit A241. However, the invention is not limited to this. For example, the notification control unit A272 may output sound for proposing behavior from the sound output unit A242 or may output the sound while displaying the presentation information on the display unit A241. A light emitting unit may be provided. The light emitting unit may emit light when the presentation information is displayed.

In the fourth and fifth embodiments, when the behavior supporting apparatus A2 enters the communicable range by the vending machine AC, the vending machine AC causes the purchase button AC1 of the article of the enjoyment target to blink. However, the invention is not limited to this. For example, the vending machine AC may control the purchase button AC1 to be in a lighting state or may control all other commodities to be in a sold-out state.

In the fourth and fifth embodiments, the stores (the store AA, the store AB, and the vending machine AC) are displayed on the route guide screen ASC2. However, the invention is not limited to this. For example, according to a state of the user, only a store (e.g., the store AA) closest from the position of the user may be displayed or only a store having the largest stock may be displayed. The stores (the store AB and the vending machine AC) other than the store A may be displayed in a semitransparent state. Further, the store A may be displayed to be highlighted (e.g., vibrate or blink).

In the fourth and fifth embodiments, when the user is located in the store AA, when it is determined that the user enters the store AA, the route generating unit A281 generates a route from the entrance of the store AA to the display position of the “ww water” on the basis of the acquired display position of the “ww water” in the store AA and generates the store guide screen including the route. However, the invention is not limited to this. For example, a message such as “Welcome. The ww water is on the third shelf on the right side as you faces” may be displayed on the display unit of the terminal apparatus PT1 set in the store AA. Further, the message may be displayed on the display unit A241.

In the fourth and fifth embodiments, the behavior supporting apparatuses A2 and A2A are the wearable apparatuses worn by the user. However, the invention is not limited to this. For example, the behavior supporting apparatuses A2 and A2A may be configured by a detecting apparatus that detects the biological information and the body motion information and an information processing apparatus (a smart phone, etc.) that analyzes the information detected by the detecting apparatus and proposes and notifies behavior.

In the fourth embodiment, the storing unit A26 stores the map information. However, the invention is not limited to this. For example, the map information may be stored in the storing unit of the server 3 or the smart phone. The server 3 or the smart phone may generate a route presented to the user. The behavior supporting apparatus A2 or the information processing apparatus such as the smart phone communicating with the behavior supporting apparatus A2 may present the route.

In the fourth embodiment, the operation unit A21 is configured by the physical keys, the touch panel, and the like provided on the housing of the behavior supporting apparatus A2. However, the invention is not limited to this. For example, the detecting apparatus may detect tap operation of the user as input operation. In this case, whether the tap operation is performed only has to be determined on the basis of an acceleration value detected by the body-motion-information detecting unit A222. Alternatively, a detecting unit capable of detecting the tap operation may be separately provided.

What is claimed is:

1. A behavior supporting apparatus comprising:
a biological-information detecting unit configured to detect biological information of a user;
a desire estimating unit configured to estimate a desire of the user on the basis of the detected biological information; and
a behavior presenting unit configured to present behavior with which the user can enjoy at least one of a service and an article corresponding to the estimated desire of the user.

2. The behavior supporting apparatus according to claim 1, further comprising an abnormality determining unit configured to determine whether the detected biological information is within a normal range, wherein
the desire estimating unit estimates a desire of the user when it is determined that the biological information is not within the normal range.

3. The behavior supporting apparatus according to claim 1, further comprising a body-motion-information detecting unit configured to detect body motion information of the user, wherein
the desire estimating unit estimates a desire of the user on the basis of the detected biological information and the detected body motion information.

4. The behavior supporting apparatus according to claim 1, further comprising:
a notifying unit configured to notify various kinds of information; and
an article-information acquiring unit configured to acquire, from a server configuring a point-of-sales-information managing system that manages article information concerning each of a plurality of articles, the article information concerning an article corresponding to a desire of the user, wherein
the behavior presenting unit causes the notifying unit to notify the article information acquired by the article-information acquiring unit.

5. The behavior supporting apparatus according to claim 1, further comprising:
a notifying unit configured to notify various kinds of information;
a position-information acquiring unit configured to acquire a present position of the user; and
a place-information acquiring unit configured to acquire, from a server configuring a point-of-sales-information managing system that manages place information concerning a providing place where an article and a service can be provided, on the basis of the acquired present position of the user, the place information indicating a place where the user can enjoy at least one of a service and an article corresponding to a desire of the user, wherein
the behavior presenting unit causes the notifying unit to notify the acquired place information.

6. The behavior supporting apparatus according to claim 5, further comprising a route generating unit configured to generate a route from the present position of the user to a place indicated by the place information, wherein
the behavior presenting unit causes the notifying unit to notify one of the generated route and time required in moving along the route.

7. The behavior supporting apparatus according to claim 5, further comprising a user-information acquiring unit configured to acquire user information including a behavior history of the user acquired from the position information of the user detected by the position-information acquiring unit, wherein
the behavior presenting unit presents the behavior based on the user information.

8. The behavior supporting apparatus according to claim 1, further comprising:
a storing unit configured to store a table in which the detected biological information, an estimated desire of the user, and means for satisfying the desire of the user are associated; and
a treatment method determining unit configured to determine, on the basis of the table, a treatment method that satisfies the desire of the user.

9. The behavior supporting apparatus according to claim 1, wherein the biological information includes at least any one of a pulse wave, a heartbeat, a blood pressure, a body temperature, a blood sugar level, a perspiration amount, and a state of pupils of the user.

10. A behavior supporting system comprising:
a detecting apparatus configured to detect and transmit biological information of a user; and
a server configured to process the biological information transmitted from the detecting apparatus, wherein
the detecting apparatus includes:
a biological-information detecting unit configured to detect the biological information;
a detecting-apparatus-side transmitting unit configured to transmit the detected biological information; and
a notifying unit configured to notify information received from the server, and
the server includes:
a desire estimating unit configured to estimate a desire of the user on the basis of the biological information received from the detecting apparatus;
a behavior presenting unit configured to present behavior with which the user can enjoy at least one of a service and an article corresponding to the estimated desire of the user; and
a server-side transmitting unit configured to transmit behavior information indicating the behavior to the detecting apparatus.

11. A behavior supporting method comprising:
detecting biological information of a user;
estimating a desire of the user on the basis of the detected biological information; and
presenting behavior with which the user can enjoy at least one of a service and an article corresponding to the estimated desire of the user.

12. A behavior supporting apparatus comprising:
a biological-information detecting unit configured to detect biological information of a user;
an input unit to which desired behavior, which is behavior that the user desires to carry out, is input;
a desired-behavior acquiring unit configured to acquire behavior content of the input desired behavior;
a behavior determining unit configured to determine on the basis of the detected biological information whether the user has a problem in carrying out the desired behavior; and
a behavior presenting unit configured to present, when the behavior determining unit determines that the user has a problem in carrying out the desired behavior, on the basis of the biological information, alternative behavior that the user is determined by the behavior determining unit as having no problem in carrying out.

13. The behavior supporting apparatus according to claim 12, wherein the alternative behavior is behavior that is based on the biological information and conforms to the desired behavior and that the user is determined by the behavior determining unit as having no problem in carrying out.

14. The behavior supporting apparatus according to claim 12, wherein the desired behavior is behavior with which the user enjoys an enjoyment target including at least one of a service and an article.

15. The behavior supporting apparatus according to claim 14, further comprising an article-information acquiring unit configured to acquire, from an information processing apparatus that manages article information concerning each of a plurality of articles, the article information concerning an article included in the enjoyment target of the alternative behavior, wherein
the behavior presenting unit presents the article information acquired by the article-information acquiring unit.

16. The behavior supporting apparatus according to claim 14, further comprising:
a position-information acquiring unit configured to acquire a present position of the user; and
a place-information acquiring unit configured to acquire, from an information processing apparatus that manages place information concerning a providing place where an article and a service can be provided, on the basis of the acquired present position, the place information indicating a place where the user can enjoy the enjoyment target corresponding to at least one of the desired behavior and the alternative behavior, wherein
the behavior presenting unit presents the acquired place information.

17. The behavior supporting apparatus according to claim 16, wherein the behavior presenting unit presents at least one of a route from the present position to the place where the enjoyment target can be enjoyed and time required in moving from the present position to the place where the enjoyment target can be enjoyed.

18. The behavior supporting apparatus according to claim 16, further comprising a user-information acquiring unit configured to acquire user information, which is information concerning the user input to the input unit, wherein
the behavior presenting unit presents the alternative behavior base on the user information.

19. The behavior supporting apparatus according to claim 12, wherein the behavior determining unit determines, on the basis of whether the detected biological information is within a normal range, whether the user has a problem in carrying out the desired behavior.

20. The behavior supporting apparatus according to claim 12, further comprising a body-motion-information detecting unit configured to detect body motion information of the user, wherein
the behavior determining unit determines on the basis of the biological information and the body motion information whether the user has a problem in carrying out the desired behavior.

21. The behavior supporting apparatus according to claim 12, further comprising:
a storing unit configured to store a table in which the desired behavior, the biological information, and the alternative behavior are associated; and
an alternative-behavior determining unit configured to determine, on the basis of the table, the alternative behavior corresponding to the input desired behavior and the detected biological information, wherein
the behavior presenting unit presents the determined alternative behavior.

22. The behavior supporting apparatus according to claim 12, wherein the biological-information detecting unit detects, as the biological information, at least any one of a pulse wave, a heartbeat, a blood pressure, a body temperature, a blood sugar level, a perspiration amount, and blood alcohol concentration of the user.

23. A behavior supporting system comprising:
a detecting apparatus configured to detect and transmit biological information of a user; and
an information processing apparatus configured to process the biological information transmitted from the detecting apparatus, wherein
the detecting apparatus includes:
a biological-information detecting unit configured to detect the biological information;
an input unit to which desired behavior, which is behavior that the user desires to carry out, is input;
a desired-behavior acquiring unit configured to acquire behavior content of the input desired behavior;
a detecting-apparatus-side transmitting unit configured to transmit the detected biological information and the acquired behavior content of the desired behavior; and
a notifying unit configured to notify information received from the information processing apparatus, and
the information processing apparatus includes:
a behavior determining unit configured to determine on the basis of the biological information received from the detecting apparatus whether the user has a problem in carrying out the desired behavior;
a behavior presenting unit configured to present, when the behavior determining unit determines that the user has a problem in carrying out the desired behavior, on the basis of the biological information, alternative behavior that the user is determined by the behavior determining unit as having no problem in carrying out; and
a processing-apparatus-side transmitting unit configured to transmit behavior information indicating the alternative behavior to the detecting apparatus.

24. A behavior proposing method performed using a behavior supporting apparatus that proposes behavior corresponding to biological information of a user, the behavior proposing method comprising:
acquiring behavior content of desired behavior input by the user and desired by the user to carry out;
determining on the basis of the biological information of the user whether the user has a problem in carrying out the desired behavior; and
proposing, when it is determined that the user has a problem in carrying out the desired behavior, on the basis of the biological information, alternative behavior that the user is determined as having no problem in carrying out.
